(19) United States
(12) Patent Application Publication
(10) Pub. No.: US 2009/0099701 A1
(43) Pub. Date: Apr. 16, 2009

(54) Remote Access to Irrigation Control Systems

(75) Inventors: Mengbo A. Li, Diamond Bar, CA (US); Randall S. Mills, San Diego, CA (US)

Correspondence Address: FITCH EVEN TABIN AND FLANNERY, 120 SOUTH LASALLE STREET, SUITE 1600, CHICAGO, IL, 60603-3406, US

(73) Assignee: RAIN BIRD CORPORATION, Azusa, CA (US)

(21) Appl. No.: 11/871,833

(22) Filed: Oct. 12, 2007

(51) Int. Cl. G05D 7/06; G06F 3/048

(52) U.S. Cl. 700/284; 715/772

(57) ABSTRACT

The present embodiments provide methods, apparatuses, and systems for use in remotely accessing irrigation control systems. Some embodiments provide irrigation control systems that comprise a local irrigation system comprising a plurality of satellite irrigation controllers coupled with water delivery devices, and a computer coupled with a distributed network and the local irrigation system. The computer comprises a processor coupled with memory storing a central irrigation control that when implemented through the processor communicates with the satellite irrigation controllers to control the satellite irrigation controllers to implement irrigation by activating one or more of the water delivery devices, and a network service that when implemented by the processor provides a communication interface between the central irrigation control and the distributed network allowing irrigation information to be communicated between the central irrigation control and at least one remote device accessing the distributed network.

### FIELD OF THE INVENTION

The present invention relates generally to irrigation control, and more particularly to remotely controlling irrigation.

### BACKGROUND

There are tens or hundreds of thousands of irrigation systems that control irrigation through water deliver devices, such as sprinklers, valves, gates, drip lines and other such devices. Some of these systems employ multiple controllers to control various water deliver devices. The multiple controllers are typically distributed over different areas to implement control over the water delivery devices within an area controlled by each controller.

Still further, some systems incorporate central irrigation control that can communicate with the multiple controllers to provide instructions to the multiple controllers. These central irrigation controls allow coordination of the multiple controllers. For example, many central irrigation controls allow a user to designate a watering schedule for the multiple controllers and the central irrigation control communicates this schedule to the multiple controllers to implement the schedule.

### SUMMARY OF THE EMBODIMENTS

The present invention advantageously addresses the needs above as well as other needs through the provision of the methods, apparatuses, and systems for use in remotely accessing irrigation control systems and interacting with those systems. Some embodiments provide irrigation control systems that comprise a local irrigation system comprising a plurality of satellite irrigation controllers coupled with water delivery devices; and a computer coupled with a distributed network and the local irrigation system, the computer comprises a processor coupled with memory storing software that is implemented by the processor, where the software comprises: a central irrigation control that when implemented through the processor communicates with the satellite irrigation controllers to control the satellite irrigation controllers to implement irrigation by activating one or more of the water delivery devices; and a network service that when implemented by the processor provides a communication interface between the central irrigation control and the distributed network allowing irrigation information to be communicated between the central irrigation control and at least one remote device accessing the distributed network.

Other embodiments provide methods of interacting with and/or controlling an irrigation system through a remote device. Some of these methods provide for the implementation of irrigation by receiving a remote request at a local irrigation central control unit from over a distributed network; determining in response to the remote request real-time information comprising current and actual information existing at the time of identifying the real-time information regarding irrigation implemented through satellite irrigation controllers controlled by the irrigation central control unit; and communicating over the distributed network the real-time information.

Some embodiments provide systems to implement irrigation. These systems comprise a user device communicationally coupled with a distributed network, the user device comprising: a processor; a user interface coupled with the processor; a communication transceiver coupled with the processor, where the communication transceiver receives real-time irrigation information including current and actual information communicated over the distributed network from an irrigation central control unit; and memory storing a network browser application implemented by the processor that when implemented by the processor utilizes the real-time irrigation information received from over the network to notify a user of at least some of the real-time irrigation information.

Further, some embodiments provide methods of controlling irrigation. These methods comprise remotely accessing a distributed network; accessing a central irrigation control unit of an irrigation system from over the distributed network; requesting an action be taken by the central irrigation control unit in controlling irrigation; and receiving real-time irrigation parameter information in response to the request.

Some embodiments are directed to irrigation control systems. These embodiments include a central irrigation control system comprising a processor and memory that stores software implemented by the processor such that the processor is adapted to: communicate with and control a plurality of satellite irrigation controllers to implement irrigation through water delivery devices; communicate over a distributed network to receive a remote request from over the distributed network from a remote device; determine in response to the remote request real-time information comprising current and actual information existing at the time of identifying the real-time information regarding irrigation implemented through the plurality of satellite irrigation controllers; and communicate over the distributed network the real-time information.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of an irrigation system according to some embodiments;

FIG. 2 depicts a simplified block diagram of one embodiment of the central control unit of the irrigation system of FIG. 1;

FIG. 3 depicts a simplified block diagram of an implementation of the central control unit of FIG. 1 according to some embodiments;

FIG. 4 depicts a simplified block diagram of an example remote device capable of communicating with the central control unit according to some embodiments;

FIG. 5 depicts a simplified block diagram of an alternative embodiment of a remote user device;

FIG. 6 depicts a simplified functional block diagram of one embodiment of an interface accessible by a user through the central control unit;

FIG. 7 depicts a simplified flow diagram of a process implemented by a central control unit in processing communications received through a distributed network from a remote user device in accordance with several embodiments;

FIG. 8 depicts a simplified flow diagram of an example of a process according to some embodiments to implement requested change received from the remote user device;

FIG. 9 depicts a simplified flow diagram of an example process according to some embodiments to identify satellite controllers and/or other devices that are associated with areas where changes requested by a user are to take effect;

FIG. 10 depicts a simplified flow diagram of an example process according to some embodiments to identify appropriate changes for the identified one or more satellite controllers and/or other devices of the irrigation system of FIG. 1;

FIG. 11 depicts a simplified flow diagram of an example process according to some embodiments of accessing an irrigation system through a remote user device; and

FIGS. 12-41 depict simplified examples of mobile devices displaying example information and/or interface displays received from a central control unit.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

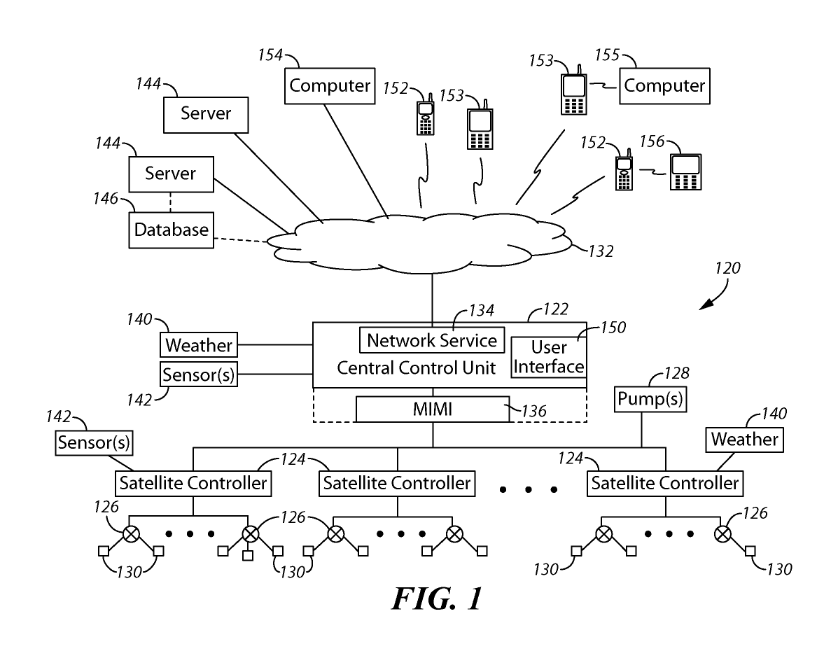

FIG. 1 depicts a simplified block diagram of an irrigation system 120 according to some embodiments. The system 120 includes a central irrigation control system or unit 122, one or more satellite controllers or sub-controllers 124, one or more relays, valves and/or field stations 126 that cooperate with one or more sprinklers, rotors, drip-lines, and/or other water stations or water delivery devices 130, and/or one or more water pump stations 128. The central control unit 122 further couples with a distributed network 132 allowing access to remote devices and/or allowing remote devices access to the central control unit.

In some instances, the central control unit 122 can couple with one or more data sources, such as a weather source 140 (e.g., evapotranspiration (ET) data sources, water pump data, and/or other relevant data sources), and sensor(s) 142 (e.g., soil moisture sensor(s), water pressure sensor(s), rain sensor(s), temperature sensor(s), wind speed sensor(s), humidity sensor(s), solar radiation sensor(s) and/or other such sensors). Additionally or alternatively, one or more of the satellite controllers 124 can couple with one or more data sources 140 and/or sensors 142. Further, the central control unit 122 can access remote data sources through the distributed network 132, such as remote servers 144 (e.g., weather service servers) and/or databases 146. In some embodiments, the central control unit includes and/or couples with a network service 134, an interface 136 and a user interface 150. In communicating with the satellite controllers 124 some embodiments employ the interface 136, which may be part of the central control unit 122 or coupled with the central control unit, to provide signal conversion so that data from the central computer controller can be accurately received and interpreted by the satellite controllers and similarly so that data from the satellite controllers can be accurately received at the central computer controller. The interface 136 device in some implementations may include a microprocessor to control local operation of the interface device and provides a conversion of data signals. Further in some implementations, the interface 136 may not include a real-time operating system and does not provide control over the communication, but instead provides a conversion of data signals.

The central controller unit 122 implements and/or controls the irrigation system in real-time, and provides a dynamic flow in implementing irrigation by substantially continuously monitoring the operations of the irrigation system 120 and when appropriate making adjustments and reacting to conditions and/or changes in and about the irrigation system 120. For example, the central control unit, in part, directs and controls the satellite controllers 124 in real-time to implement and control irrigation over the irrigation system 120. In controlling the irrigation, the central control unit 122 monitors the satellite controllers 124, sensors and/or other sources of information to identify real-time, current and accurate states of operation, statistics, conditions, status and/or parameters. Based on the identified information the central control unit 122 can dynamically control, adjust and/or alter irrigation scheduling. This allows the central control system 122 to improve and in some instances optimize irrigation, irrigation times, water usage and other such benefits. Further, because the central control unit 122 operates in a current state and monitors the status, parameters and conditions of the irrigation system 120, the central control unit has real-time information that is accurate, current, reliable and relevant. This real-time information is current and accurate based on actual conditions, parameters, states and status, as apposed to theoretic, anticipated and/or estimated conditions, parameters and/or status.

For example, some irrigation systems allow a user to define an irrigation schedule. These schedules, for example, allow a user to specify start times and durations when a group of watering devices are to be active. These start times and durations are then loaded into field controller devices for later operation. These systems typically employ a clock and implement the schedule through the field controller devices according to the defined schedule. As such, the information contained in the central control system is theoretical in nature because irrigation sequencing is assumed based on the configuration of the system at the time the field controllers were programmed. As conditions change, for example a field controller was turned off; the central control would be unaware of this change and indicate water delivery devices are active when, in fact, they are not due to the disabled field controller. Further, these controllers do not take into account actual conditions once the irrigation schedule is implemented and/or distributed to the field controllers or satellite controllers.

The real-time information identified by the central control unit 122, however, is current, accurate and actual information that is based on actual conditions and information acquired and received from the satellite controllers 124 and/or information sources 140, 142 144, 146. This real-time information allows the central control unit to dynamically implement irrigation, adjust irrigation scheduling, adapt to the dynamic hydraulic demand of the irrigation system, alter parameters and settings, control the satellite controllers and additionally provide real-time, current and actual information to a user. For example, the central control unit 122 applies a dynamic flow allocation in implementing irrigation allowing, in some instances, the central control unit to activate one or more water delivery devices (e.g., sprinklers) and to evaluate conditions over some or all of the irrigation system 120 based at least in part on the activation of the water deliver devices and to identify which if any other water delivery devices can also be activated and/or which water deliver devices can be prevented from being activated, for example, due to potential load or pressure problems or other reasoning.

The real-time implementation of the central control unit allows the central control unit to immediately adapt in real-time to changing conditions of the irrigation and/or irrigation system. For example, the central control unit can detect when one or more sprinklers need to be shut down, or are forced to shut down (e.g., by a user), the central control unit becomes immediately aware of this change of status, and can make determinations and/or adjustments to the irrigation schedule and/or implementation. As a further example, the central control unit can re-allocate the water that would have been used by the now shut down one or more sprinklers, and to activate one or more alternative sprinklers so that the system continues to operate at capacity and/or reduces wasted time by not utilizing available resources (e.g., water, water pressure, etc.). In some instances, the central control unit continuously evaluates statistics, status and other parameters to determine how to continue irrigating. The irrigation can in real-time be dynamically adjusted and can be adjusted to changing conditions. The irrigation system 120 is operated, in some implementations as a working system, rather than individual distributed pieces.

Alternatively, distributed irrigation systems, as introduced above, have multiple distributed controllers that each receives at least a relevant portion of an irrigation schedule and these multiple distributed controllers operate independently based on the relevant portion of the irrigation schedule. These distributed systems typically cannot react to changes applied at one distributed controller, each distributed controller is unaware of changes at other distributed controllers, and typically cannot compensate for changes until a new irrigation schedule is later distributed, often a day or more after any change in conditions. For example, if one or more sprinklers are shut down a first distributed controller directly controlling the shut down sprinklers may become aware of this change, but other distributed controllers typically are not aware of the change, are not made aware of the change, and cannot take advantage of the unused resources. This may not have significant effects in the case where only a single sprinkler is shut off, however, should all the sprinklers controlled by one distributed controller be shut down, a significant amount of water resources are left unused, resulting in the fact that it will take longer to complete irrigation, and is an inefficient and underutilization of resources.

Further, some remote access systems employ hand-held radios, such as radios communicating over UHF or other radio frequency. In many countries, however, the radio frequencies are controlled by governmental regulations, and often require licensing (e.g., from the Federal Communications Commission (FCC) in the United States) in order to utilize these radio frequencies. This licensing can add signification cost and complication to a remote access system. Further in some countries, access to appropriate radio frequencies cannot be obtained preventing wireless access using these radio frequencies. Additionally, these hand-held radio devices have a relatively limited range of operation. Still further, typically these hand-held radio devices have limited functionality and user interfaces, limiting the effectiveness of these devices and further limiting the type of information and/or amount of information that can be provided to a user utilizing the hand-held radio.

Some implementations of the present embodiments, however, employ cellular communications. As such, licensing is not needed and remote access to an irrigation system can be achieved through substantially any cellular communication device that can obtain a communication signal and has the capability to access a distributed network, such as the Internet. Further, because the cellular technology is employed, the range of operation is substantially unlimited as long as a signal can be established.

A user can access the central control unit 122 through an optional user interface 150 of the central control unit, typically, directly coupled with the central control unit. Additionally or alternatively, in some embodiments, users can remotely access the central control unit 122 through remote user devices 152-156. The remote user devices 152-156 can couple with the network 132 and access the central control unit through the network. The access to the network can be through wired or wireless connections. For example, a network enabled wireless device, such as a cellular phone 152 with Internet browsing capabilities can wirelessly access the network 132 (e.g., through a cellular base station) to communicate with the central control unit 122 through a network service or interface 134 of the central control unit. Other wireless devices, which can be substantially any interactive two-way communication devices that include, but are not limited to, wireless smart cellular phones 153, computers, tablet personal computers, laptops, other mobile computing devices, palm-sized computing devices, Internet-capable devices and/or other devices, can similarly wirelessly connect with the network and communicate with the central control unit.

Additionally or alternatively, a computer or other user device 154 can couple through a wired or wireless modem or other network connection to connect with the network 132 to gain access to the central control unit 122. In some implementations, user devices 155 such as computers, tablet personal computers, laptops and/or other devices can couple with a cellular phone 152 or smart phone 153 to gain wireless access through the phone to the network. Similarly, a personal digital assistant (PDA), pocket PC or other such user device 156 can connect with the network 132 through a cellular phone 152, smart phone 153 or otherwise connect with the network to communicate with the central control unit 122. The connection between the computer 155 or portable PC 156 and a wireless device (e.g., cellular phone 152, smart phone 153 or the like) can be through wired or wireless connections. In some embodiments, the connection between the computer 155 or portable PC 156 can include Bluetooth, 802.11a,b or g, and/or substantially any other relevant wireless communication protocol. The wireless remote devices can wirelessly communicate through substantially any wireless communication system, protocol, and/or infrastructure, such as for example a cellular infrastructure that generally comprises a base station, which typically controls wireless links with one or more of the wireless remote devices, and an operations and maintenance center, which can comprises a mobile switching center performing the switching of calls between the mobile devices and other fixed or mobile network users, manages mobile account services, authentication, and/or oversees operation and setup of one or more wireless networks.

Accessing the central control unit 122 allows a user to obtain real-time information from the central control unit in evaluating, analyzing, auditing, diagnosing, adjusting, altering and/or considering the operation of the irrigation system 120. Further, because the central control unit operates in real-time instructions, commands and/or communications received from a user can, when relevant, be acted upon immediately by the central control unit. Additionally, real-time information can be returned to the user in response to the user instruction, command and/or communication. The returned real-time information can include results due to changes implemented, status information, parameters, confirmation of changes to parameters, information regarding denial of implementing instructions, estimated time when a user instruction can be implemented, device information and/or identification, and/or substantially any relevant information about the current status of the irrigation system. Historical data and/or estimated future data additionally or alternatively can be provided in some embodiments when appropriate.

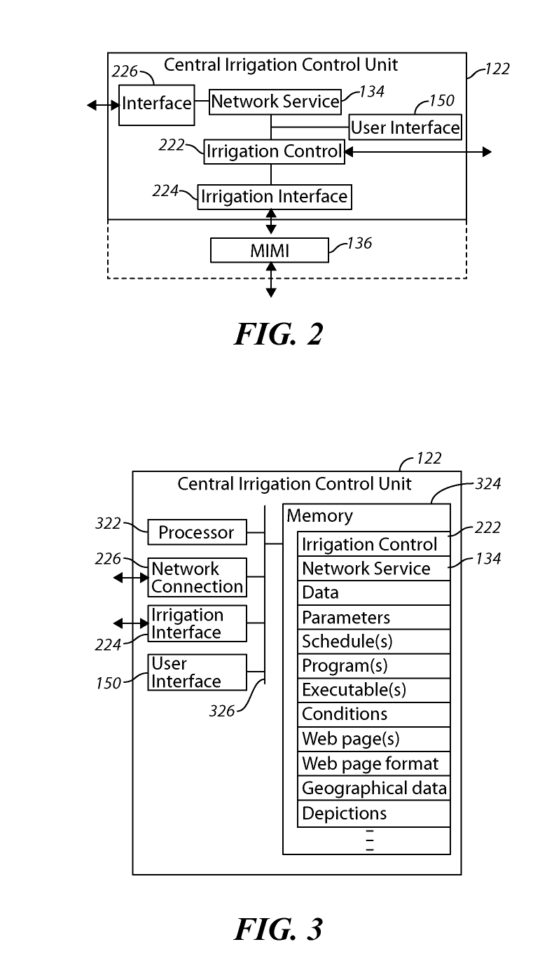

FIG. 2 depicts a simplified block diagram of the central control unit 122. The central control unit includes the network service 134, the user interface 150, central irrigation control 222, an irrigation interface 224 and a network interface 226. Additionally in some embodiments, the central control unit includes and/or couples with a system communication interface 136. The central irrigation control 222 manages the irrigation through the irrigation system 120, maintains scheduling, tracks and/or monitors parameters, conditions, information and the like, implements irrigation and controls satellite controllers, and communicates with the user interface 150. By communicating with the satellite controllers 124 the central irrigation control 222 implements irrigation over the irrigation system 120. The irrigation interface provides a communication interface in communicating with the satellite controllers and/or one or more of the weather source 140 and/or sensors 142.

The system communication interface 136 can additionally be incorporated in the central control unit 122 and/or coupled with the central control unit to provide at least in part signal conversion. The signal conversion is implemented in some embodiments so that data from the central computer controller can be accurately received and interpreted by the satellite controllers 124 and similarly so that data from the satellite controllers can be accurately received at the central computer controller. The interface device in some implementations may include a microprocessor to control local operation of the interface device. Typically, however, the system communication interface 136 does not provide control over the communication, but simply provides conversion of data signals. In some embodiments, the system communication interface 136 is implemented through products commercially available such as cluster control unit(s), a Two-wire interface (TWI), small decoder interface/large decoder interface (SDI/LDI) two-wire interface available from Rain Bird Corporation, or other such interfaces. Irrigation links distributing power to sprinkler solenoids for operation are available in a variety of technologies. In the case of the MIM or TWI, irrigation control requests are parsed and distributed to a field controller according to the operating language of the receiving device. Signal conversion and formatting capability is implemented in the MIM or TWI. In some instances, the MIM is functionally similar or equivalent to a TWI. In instances where the receiving device includes a decoder system, the LDI or SDI performs at least two functions: 1) providing power to the decoder devices located along the wire path which can, in some instances, be used to energize solenoids on a sprinkler or valve; and 2) receive control requests, for example in ASCII, from the central control and convert them to the appropriate signaling language used by the decoder device. Some redundancy and surge protection benefits are offered in some embodiments by these interface devices as well.

The network service 134 provides the central control unit with the ability to supply content and/or information over the network that remote user devices 152-156 can utilize by interfacing between the network 132 and the central irrigation control 222, and receive communications from remote devices and provides decoding, conversion, formatting and/or other signal processing to allow the communication to be accurately interpreted by the central irrigation control 222. In some implementations, the network service includes an Internet web server that configures web pages and/or data to be communicated over the network and receives responses based on the delivered web pages and/or data. The network communication and/or connection from the central control unit 122 can be implemented through substantially any relevant connection including but not limited to dial-up, digital subscriber line (DSL), cable, satellite and other relevant connections. The network service can operate on a static IP address typically bounded to a fixed connection or a dynamic Internet protocol (IP) address that typically is renewed each time the network service connects with the network 132, where the IP address can be registered and/or a domain name is registered.

In some embodiments, the network service 134 is defined as a server application installed on a computer where the central irrigation control 222 is also implemented. In part, the network service 134 can provide synchronization for the transfer of data between the network and the central irrigation control 222. Data from the network service can be supplied using, for example, Transmission Control Protocol/Internet Protocol (TCP/IP) or other relevant communication protocols, as Internet web pages, data that is usable by a client application on the user device (e.g., user device 152), and/or other relevant forms. For example, the network service 134 can at least in part be implemented through software of an operating system or network browser application, such as Windows Server of the Windows Internet Explorer application from Microsoft Corporation.

The web server in some implementation is configured as an interface between the network service 134 and the central irrigation control 222 to serve appropriate web pages, parse data requests and provide that information to the central irrigation control. For example, when user of the remote device 152 requests a status report for or from a pump station, that request is received though the network service, accepted by the web server and converted into an appropriate request for the central irrigation control. Pump data returned by the central irrigation control is received by the web service application, formatted appropriately and placed into a web page. The web paged is then passed onto the network service 134 to be received by the remote device for display as a web page. In another example, a user of the remote device may wish to edit data in a central control database (e.g., an irrigation schedule). An appropriate link is selected on the remote device 152 and the web server application provides an input form, in some instance, filled out with the data already present in the database. The user makes the desired edits, submits them to the web server which extracts the relevant data and directs the data to the central irrigation controller 222 to take appropriate action, such as write the new data into the central control database.

The network interface 226 provides a physical and/or wireless connection with the network. For example, the network interface 226 can establish communication links through a plurality of media such as a wireless modem, a telephone modem, wireless networks, Ethernet interface, hard wired or fiber optic systems, and/or other relevant interfaces to interface with the network 132.

FIG. 3 depicts a simplified block diagram of an implementation of the central control unit 122 according to some embodiments. The central control unit includes one or more processors or microprocessors 322, one or more memory and/or digital storage 324, the network interface 226, the irrigation interface 224, the user interface 150 and one or more communication links 326. In some embodiments, the central irrigation control 222 and/or network service 134 is implemented by software stored in the memory 324 and executed on the processor 322, or otherwise stored and executed in firmware. Further, the one or more processors 322 can be implemented through logic devices, hardware, firmware and/or combinations thereof. Thus, the irrigation control and/or network service application may be performed using substantially any relevant processor logic or logic circuit.

The memory 324 stores software programs, executables, data, irrigation control programming, scheduling, runtime parameters, soil conditions and parameters, web pages, web page formatting, geographic data, depictions of geographic areas, and/or other relevant programs and data. The memory can be implemented through RAM, ROM, EPROM, flash memory or other memory technology, CD-ROM, digital video disk (DVD) or other optical disk storage, magnetic storage, and/or substantially any other medium or combinations of medium and/or storage that can be used to store the desired information and that can be accessed by the processor(s) 322. In many embodiments, the central control unit 122 is implemented through a computer, such as personal computer (PC), laptop or the like that includes the processor(s) 322, memory 324 and interfaces.

The network service 134, in part, allows remote users to access the irrigation control unit 122 to implement changes, receive status information, perform diagnostics and substantially any action and/or receive substantially any information that is available through the central control unit 122. In forwarding information to a user device, in some embodiments, the network service identifies the type of device being used by the user to access the central control unit to determine the type of information and/or content to be forwarded, and/or how to format the information and/or content. For example, cellular phone devices typically have limited displays and/or display functionality, while PDAs and/or portable PC devices have enhanced display capabilities relative to many cellular phones, while laptops and other computers provide further enhanced display capabilities. As such, the network service 134 can identify the remote device and format the content or information relative to the type of display and/or display capabilities available through the remote device. As a further example, the navigation on a cellular phone through content, options and/or listings can be limited due to often limited user options (e.g., many cellular phones have a limited number of buttons that allow a user to scroll through menus and/or listings, and further the limited displays often limit how data, choices and/or options can be represented). In some implementations, the web server application includes an operator language allowing the user to provide richer control parameters using the simplified keypad of a cellular phone. The operator language may allow a user to define short cut keys, which may depend on a current state of operation and/or a web page being accessed. For example, the user may define the “1” button to turn something on and the “2” button to turn something off, thereby simplifying and/or eliminating a need to separately select and on or off option or button. Portable PCs and/or PDAs, however, often provide a more robust navigation than cellular phones, often through touch screens and/or the use of stylus, much like a mouse or other pointer on a computer, and further can display content, options, selections and the like in a more user friendly format. Still further, PDAs and/or portable PCs may have greater digital storage capabilities than cellular phones. Therefore, the network service 134 can format content and/or limit how and when content is supplied to the remote user device 152-156.

In some embodiments, the central control unit 122 is implemented on a general purpose personal computer including central irrigation control software 222 that implements at least in part the central control functionality. For example, the central irrigation control software 222 may be implemented through Cirrus™, MDC, SiteControl™, Nimbus II™, Stratus II™, StratusLT™, Maxicom™, Maxicom2™, IQ™, and other such central control software).

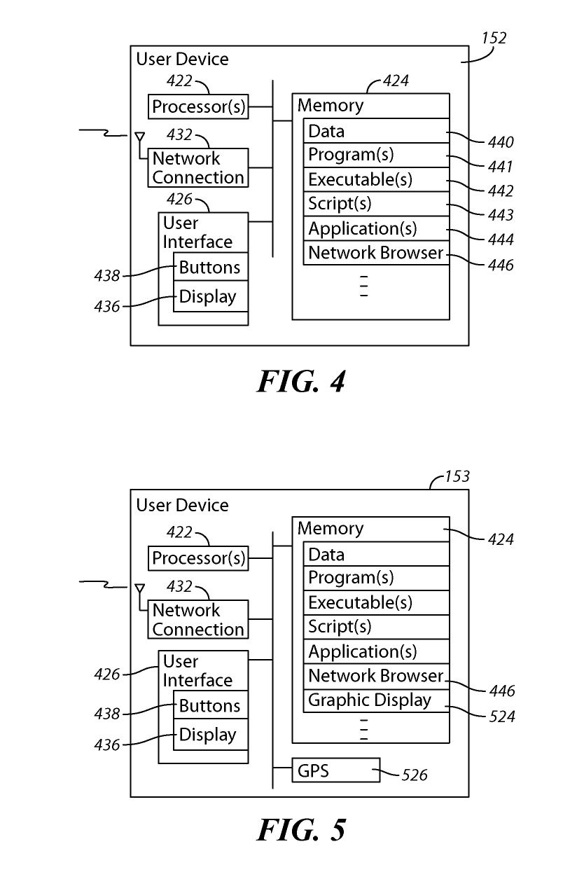

FIG. 4 depicts a simplified block diagram of an example remote device, such as remote user device 152. The remote user device includes one or more controllers typically implemented through one or more processors 422, memory 424, user interface 426, and communication transceiver 432. The processor 422 can be implemented through one or more microprocessors, microcontrollers, logic devices, hardware, firmware, other such processing devices or combinations thereof. The user interface includes a display 436 and one or more buttons or keys 438. In some instances the display can be a touch screen, and the interface can additionally include a stylus or other such pointing device. The communication transceiver allows the remote device to wirelessly communicate with the distributed network 132.

The memory can be substantially any memory implemented through RAM, ROM, EPROM, flash memory or other memory technology. The memory stores data 440, programs 441, executables 442, scripts 443, applications 444 allowing the device to operate, and/or other such data. Typically, the memory stores a network browser application (e.g., an Internet browser application) 446 that can display information received from the network and allow a user to communicate over the network. In many implementations, the remote user device 152 does not include specialized software or applications in order to communicate with the central control unit 122 or to receive real-time information from the central control unit. The communication transceiver in many embodiments is a wireless transceiver, such as a cellular communication transceiver allowing the user device 152 to wirelessly communicate through a base station of a cellular carrier to receive and transmit communications and data.

FIG. 5 depicts a simplified block diagram of an alternative embodiment of a remote user device, for example, user device 153. Similar to the user device 152, the user device 153 includes one or more controllers typically implemented through one or more processors 422, memory 424, user interfaces 426, and communication transceivers 432. Some remote user devices 153 can optionally include a graphics screen or display application or software 524 stored in memory 424 and allow the display 436 to display an image, pictorial or geographical representation an irrigation system or an area irrigated by the irrigation system 120, which in some instances is implemented at least in part through the network browser application 446 and/or displayed through the network browser application. Further, some remote user devices include global satellite positioning (GPS) capabilities 526 or other such location detection applications, which may be implemented through hardware, software or a combination of hardware and software. In other embodiments, the remote device can couple or communicate with an external device that can identify positioning information, such as global positioning information. This GPS capability 526 allows the remote user device to receive current positioning information and to communicate the current positioning information to the central control unit 122 allowing the central control unit to provide the user with information relevant to the user's current location.

As introduced above, the irrigation control 222 manages the irrigation through the irrigation system 120 and communicates with the satellite controllers 124, in part, to implement irrigation over the irrigation system 120. The irrigation control 222 further allows a remote user device to access the irrigation control and obtain real-time parameter settings, conditions, statistics and/or other relevant information, as well as allowing remote users to implement in real-time or delayed implementation activations and/or changes to irrigation, parameters and/or conditions, and to receive real-time information resulting and/or in response to the changes and/or activations. Some examples of changes include, but is not limited to: activating one or more water delivery devices; activating one or more satellite controllers to activate some or all of the water delivery devices associated with that satellite controller; changing scheduling (immediate change or delayed change); halting some or all of an active irrigation; obtaining parameters of the irrigation system; receiving information why commands cannot be implemented; and other such information. A remote user device can be substantially any relevant remote user device, such as the remote user devices 152-156 described above. For simplicity, the description below references remote device 152, however, the remote device can be any relevant remote device including one or more of the remote devices 153-156.

In operation, the remote user through the remote device 152 accesses the central control unit 122 to request parameters, settings, conditions, statistics and/or other information, request actions be taken, request changes be implemented and/or to submit other relevant request, commands or the like. In several embodiments, the central control unit is configured to deliver or serve information to the remote device to allow the user to be able to make such requests, e.g., the central control unit serves web pages to the remote device displayed by the browser that allow a user to transmit such a request to the central control unit. In some implementations the web pages delivered by the central control unit provide a control interface to the remote device. The central control unit evaluates the communication from the remote device and determines appropriate actions to be taken. The action can include forwarding scheduling information, other relevant information and/or real-time information to the user at the remote device 152. The real-time information can be settings, conditions, results and/or effects causes by actions taken and/or other real-time information. This information is transmitted in a format that can be displayed at the remote device, e.g., displayed by the browser 446 via the user interface 426. Further, a central control interface can be dynamically delivered to the remote device 152, for example, through web pages, and as such the remote device does not need to maintain or store an additional application to communicate with the irrigation system and/or implement irrigation control other than the network access or browser.

The information available at the remote user device 152 can include substantially any data that is available through the central control unit 122, which may be limited by authority or accessibility levels of a user as further described below. The available information can include, but is not limited to status information (e.g., station running status, pump status, weather data (historical and/or current), portion of irrigation system active, and the like) and data that can be viewed and/or edited (e.g., program and schedule settings, station settings, weather ET, and other such data). Additionally, substantially any action can be implemented, management control utilized, and/or commands issued through the remote user device to allow interaction with the irrigation system 120. Some examples of actions that can be implemented through the remote user device 152 can include turning on and off one or more water delivery devices, satellite controllers, pumps and other devices of the irrigation system 120; pausing and resuming an irrigation schedule, watering and irrigating from water delivery devices, satellite controllers and the like; group or block turning on and block turning off where blocks of devices are predefined or user defined; block advance where an irrigation schedule can be advanced a block of time or a block of devices of the irrigation system 120; system enable or disable of automatic program start time(s); system open or close of access windows; system cancel all irrigation; system update ET from current weather data; and other such action. As described above and further below, some actions and commands may be limited to certain users having sufficient authority.

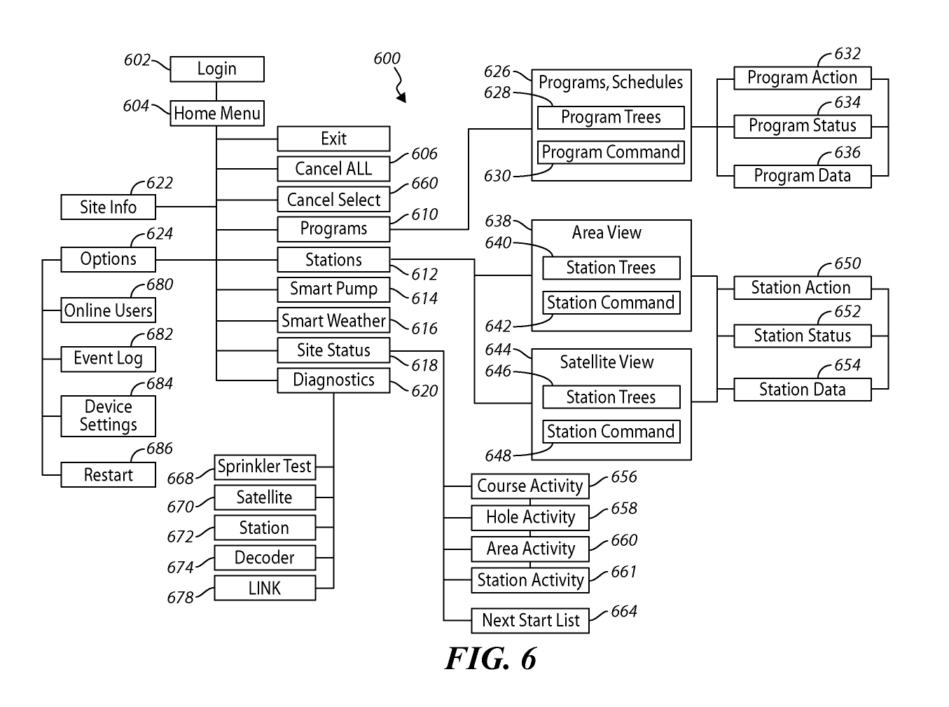

FIG. 6 depicts a simplified functional block diagram of an interface 600 accessible by a user through the central control unit 122. Again, the user can access the central control unit from a remote device 152, and similarly can access the central control unit directly from the computer upon which the central control unit operates. The interface 600 typically is implemented through one or more software applications running on a computer that implements the central control unit 122. When accessed from a remote device the interface 600 or relevant portions of the interface are transmitted to the remote device. In some embodiments, upon accessing the central control unit a user logs in through a log-in application 602. The log-in provides a measure of protection to the irrigation system 120, central control unit and/or computer implementing the central control unit. Typically, the user has a user name and one or more levels of passwords. Further, in some instances, the log-in when communicating with a remote device may attempt to authenticate the remote device, for example, by determining a unique identifier.

Once logged-in a user interfaces with a main or home menu application 604. The main menu provides general navigation through the irrigation system control provided by the central control unit 122. Typically, the main menu includes a plurality of options or functions that are selectable by the user. The menu can be displayed as a listing of functions where a user can enter an alphanumeric character corresponding with the desired functions of the listing, can be selectable options or buttons (e.g., selectable through a touch screen, stylus, mouse or the like), or other similar selectable listings. The available functions can include substantially any relevant functions. For example, some embodiments can include a cancel all function 606, a cancel select function 608, a programs function 610, a stations option 612, a pump function 614, a weather function 616, a site status function 618, a diagnostics function 620, a site information function 622 and an options and/or management functions 624. Some of the functions can correspond with actions to be taken by the central control unit while other functions provide users with further functions associated with the selected function.

In some instances, the cancel all function 606 is included and allows a user to override an irrigation schedule that is currently active and/or is to be activated, generally within a window of time (e.g., within an hour, within 24 hours, or other such windows of time). Upon selection of the cancel all function 606 the central control communicates with satellite controllers that are currently implementing irrigation to halt irrigation, and further instructs those satellite controllers that have not yet been activated but are scheduled to implement irrigation to redefine settings so that irrigation is not started and/or prevent irrigation through the water delivery devices controlled by the satellite irrigation system. Additionally in some embodiments, the cancel all function can communicate with one or more pump stations to cause the pump stations to halt water delivery.

The cancel select function 608 similarly results in the central control halting active or pending irrigation, however, the central control limits which satellite controllers, water delivery devices, pumps and/or other relevant devices of the irrigation system 120 to stop irrigation or activation. In some instances, upon a selection of the cancel selection function a listing can be provided allowing a user to specify which devices the cancel command is to apply.

The program function 610 provides a user with access information and implements actions for programming, scheduling, activation, deactivation and other such controls over irrigation, satellite controllers, water pumps and other devices of the irrigation system 120. Upon selection of the program function 610 the interface 600 directs the user, in some implementations, to a program and/or scheduling field 626 allowing a user to access a program tree function 628 and a program command function 630, which in turn provide a user to access appropriate program actions 632, status 634 and/or data 636.

The stations function 612 allows a user to access one or more listings and/or geographic representation of stations, pump stations, satellite controllers and/or other devices of the irrigation system 120, such as an area view field 638 and a satellite view 644. The area and satellite views each provide station tree options 640, 646 and station command options 642, 648, respectively, that direct a user to station actions 650, station status 652 and/or station data 654.

The pump function 614 allows a user to access information and/or control one or more pump stations operating in the irrigation system 120. The control may include acquiring current status information from the pump station, current flow rate supplied by pump station, pump station alarm status, pump station system pressure reading, available capacity, theoretical flow capacity, current actual flow, current pressure and/or other such information. Additionally in some implementations, the pump function 614 may allow users with sufficient access levels as described below to set limits and/or parameters of one or more pumps.

Similarly, the weather function 616 allows a user to access and/or control one or more weather stations, sensors and/or other devices that can be utilized in determining irrigation runtimes, activation and other such control. For example, the weather function may provide access to current status information from a weather source such as an on-site or web-based weather station, access current weather conditions including wind speed, rainfall, ET, air temperature and other such information.

The site status function 618 provides a user with additional functions or options for obtaining information and statistics about the irrigation system 120 and the areas irrigated by the irrigation system. The functions associated with the site status can include, for example when the area being irrigated is a golf course, course activity 656 to inform the user which one of several possible courses currently have water running and the total flow rate of water currently being supplied to that areas, hole activity 658 to inform the user which golf holes on a given course currently have water running and the total flow rate actively being supplied to those golf holes, area activity 660 to inform the user which areas of a given golf hole currently has water running (e.g., greens, tees, fairways, roughs, etc.) and the total volume of water being supplied to those areas, station activity 662 to inform the user which specific water delivery devices within a given area of a golf hole currently has water running, the total flow rate of water being discharged by that device, the length of time that device has been running and how much time that device has left to run, and next irrigation start list 664 to inform the user which programs are scheduled to start, for example, in the next several hours and at what time.

The diagnostic function 620 similarly provides a user with additional functions and/or options to evaluate the irrigation system 120, its performance and the performance of the devices of the system, station operation information, troubleshooting information such as radio status on wireless irrigation systems and other diagnostic information. In some instances, the additional functions associated with the diagnostics function can include, but is not limited to, sprinkler testing 668, satellite controller diagnostics 670, station testing 672, decoder diagnostic 674, communication link diagnostics 678 (wired and/or wireless), and other such diagnostics. Remote user devices with access to the diagnostic functions can provide detailed diagnostic information to the user for troubleshooting and other purposes.

The options or management functions 624, in some implementations, provides further options available through the central control unit 122. The options functions can include, for example, remote or online user options 680, event log 682, device settings option 684, restart option 686 and other such options. The online user option provides a listing of authorized users currently logged on to the system to access the central control unit and interact with the irrigation system, provides a function to temporarily limit or prevent a selected user from accessing or interacting with the central control unit, and other such functions.

In some embodiments, there can be multiple levels of users as introduced above, with each level having different access rights available to the users of that level (e.g., administrator, power user, regular user, guest, or other such user levels). For example, there can be an administration level that allows users at this level complete and full access to the central control unit 122 and other devices of the irrigation system 120, including adding or removing users to or from a list of users having access to the central control unit and/or redefining users access level. Other levels may include a master or power user that provides users of this level with complete access with the exception of adding users or redefining a users access level, including redefining parameters, setting and/or adjust irrigation scheduling, halting irrigation, performing diagnostics, auditing and other such functions; a user level that allows a user to activate limited duration irrigation and perform diagnostics, which would typically be assigned grounds crew and the like; a temporary user or guest level that allows a user a limited accessibility (such as limited to simply status information) and/or limited duration to access the system, which may include sub-levels similar to the regular users levels; and substantially any other relevant user level. Further, some embodiments limit access and usage of some or all of the online user options 680. For example, the ability to add or remove users from a list of authorized users may be limited to administration users. Additionally, the distribution of data may be limited and/or selectively accessible depending on a user's level of access. Typically, different users play different roles in implementing and utilizing an irrigation system 120 and some information may not be needed for some types of users. The irrigation system can be configured based on authorization levels to limit the data, options, functions and/or features. For example, a basic user may only be authorized to receive ET data, while a power user may be authorized to compose ET by, for example, editing air temperature and wind speed.

The event log 682 allows a user to access one or more logs and/or records tracked by the central control unit, and in some instances define how information is logged. The one or more logs or records can store substantially any relevant information associated with the irrigation system and/or remote access. Some of the information can include, but is not limited to, the users that access the system, amount of time they spent on the system, the information accessed, any changes implemented, any diagnostics, and substantially any other information associated with the operation of and access to the irrigation system 120. For example, in some implementations, every interaction with the irrigation system, including user's name, time and date of the input and the action performed for an interaction. The log or other tracking provides additional functionality to the central irrigation control 222, which can include data entry, diagnostic, control and status features. The information utilized can include the tracked activities of each remote and/or local user in a detailed event log that can be used to determine when and by whom changes were made to the irrigation system 120, generate reports regarding the activities and track statistics about the use of the irrigation system.

The device settings functions 684 allows access to a listing of devices associated with the one or more remote devices utilized by the users in remotely accessing the irrigation system 120. This device settings information can include, but is not limited to devices' screen size or type, number of lines of text per screen, how many alphanumeric characters per line, memory capacity, and other such device settings. The device settings can be defined by a user or can be acquired by the central control unit 122 while communicating with a remote device. Knowing and/or auto-detecting device capabilities allows the central control unit 122 and network service 134 to configure communications (e.g., web pages) appropriate for a type of remote user device and/or the screen type or capabilities of a device. Additionally, in some embodiments, the device settings functions allow a user to access one or more listings of settings and/or parameters associated with the devices of the irrigation system 120.

The restart option 686 allows the remote control to reset the server application on the central control unit instances where certain parameters are reset, locally or remotely, and a restart is needed to implement the new settings. Other options and/or functions can be available through the central control unit 122 and/or irrigation system, and FIG. 6 depicts an example of some of the functions and options available. Similarly, FIG. 6 shows one example of an organization of functions and options; however, other organizations of the functions can be implemented.

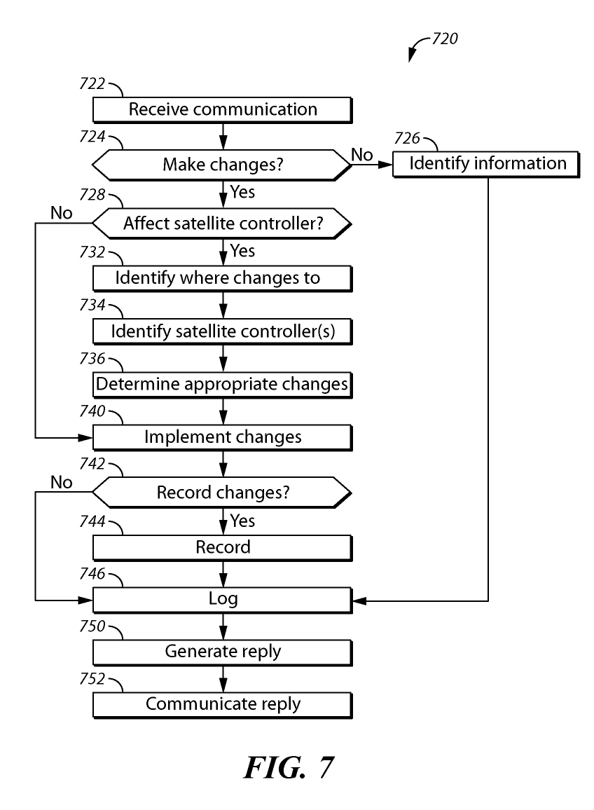

FIG. 7 depicts a simplified flow diagram of a process 720 implemented by the central control unit 122 in processing communications received through the network 132 from a remote user device, e.g., remote device 152. In step 722, the central control unit 122 receives a communication from the remote user device 152. In step 724, the central control unit determines whether changes are to be made in response to the communication. The changes and/or adjustments can be changes to an irrigation schedule; altering one or more operating states; changes in current conditions and/or operations; adjustments of flow rates; halting and/or stopping active irrigation; activations or deactivations of one or more satellite controllers, water delivery devices, pumps, and/or other devices under the control of the central control unit 122, satellite controller 124 or other device of the irrigation system 120 under the control of the central control unit; and/or other such adjustments or changes. In some implementations, the communication received in step 722 may be a request for information, such as current settings, conditions, parameters, states and/or other information that does not include implementing adjustments and/or changes. In those instances where adjustments and/or changes are not to be implemented the process 720 skips to step 726 where the request is evaluated and information to satisfy the request is identified. The information can include current status, parameters, statistics, operating conditions, weather, ET, settings and/or other relevant information. Further, the information may be information known at the central control unit and information accessible by the central control unit, such as information at a satellite controller 124. Once the information is retrieved, the process 720 then continues to step 746 and 750 where events are logged and a reply is forwarded when appropriate as fully described below.

When changes are to be implemented, step 728 is entered to determine whether the changes are to affect one or more satellite controllers or other devices of the irrigation system, and/or whether one or more satellite controllers or other devices of the system are to be notified or instructed to implement changes. In step 730, changes are implemented locally at the central control unit 122 when it is determined that no changes are to be communicated to one or more irrigation controllers. These local changed can be substantially any relevant change, such as but not limited to, changes to an irrigation schedule, adjusting parameters, defining settings, conditions and/or parameters (e.g., defining an ET data that is to be utilized by the central control unit 122 in determining run times, identifying a current temperature, restricting irrigation, preventing implementation of one or more portions of an irrigation schedule, or other such definitions), and other such changes or combinations of changes. Following step 730 the process continues to step 742 to determine whether changes are to be recorded. Some changes are simply temporary, as further described below, and as such may not be recorded.

When it is determined in step 728 that changes are to be communicated to one or more satellite controllers or other device, the process 720 continues to step 732 where the irrigation control unit 122 identifies where in the irrigation system 120 the changes are to have effect and/or are to be implemented. For example, the area can be defined as an area about a certain geographic location, one or more holes of a golf course when the area being irrigated is a golf course, an area of a hole or holes on a golf course (e.g., the greens for a certain number of holes, or the fairways), an area associated with a satellite controller, or other such areas. In step 734, one or more satellite controllers and/or other devices of the irrigation system are identified that are associated with the areas where the changes are to take affect and/or are to be implemented. In some embodiments, the central control unit further identifies other satellite controllers and/or devices of the irrigation system 120 outside the identified area that are to be affected and/or collaterally affected by the changes (e.g., changes to an irrigation schedule may have affect on pump stations and/or other satellite controllers outside an area identified for change). In step 736, appropriate changes are determined for each of the identified one or more satellite controllers, water delivery devices and/or other devices of the irrigation system 120. These changes can be substantially any relevant change, such as an instruction to halt a currently active irrigation from one or more water delivery devices, reduce a flow, changing run times, and the like, as well as changes that can be made based on the requested and/or instructed changes received from the remote user, such as changes to further optimize the irrigation system 120. For example, should an instruction be issued to halt an active irrigation from a first satellite controller, the central control unit in real-time recognizes the reduced water usage due to the halting at the first satellite controller and can determine whether to reallocate the water usage to a second satellite controller to activate irrigation from the second satellite controller instead of waiting for a predefined time when the second satellite controller is to be activated according to a previously defined irrigation schedule. The activation at the second irrigation controller may include a different irrigation schedule than was previously defined and/or applied, for example, due to the fact that the second satellite controller may be sharing a total water flow with a third satellite controller when in a previous irrigation schedule the second satellite controller had the entire water flow during its active irrigation.

In step 740, the central control unit implements the requested change. The implementation can be local at the central control unit as described above and/or can be forwarded out to one or more satellite control units or other devices on the irrigation system. In step 742, it is determined whether the issued changes are to be recorded. For example, the central control unit can determine whether the change is to be incorporated into the irrigation schedule from this point forward (e.g., until another change is issued), whether the change is to be implemented for a defined period of time (e.g., for a current week, for a current month, or other such time period), or the like. Alternatively, the change may not be recorded, for example, when the change is to be implemented a single time. In those instances where the change is not to be recorded, the process skips to steps 746 and 750 where the events may be logged and a reply generated when a reply is warranted as described below.

In those instances where changes are to be recorded, step 744 is entered where the change is recorded. For example, a change to the irrigation schedule is recorded. Some embodiments further include optional step 746 where a log or transaction history is maintained of events, access, requests and/or other relevant information is tracked and/or recorded. In step 750, the central control unit generates a reply to the communication received from the remote user device 152 when a reply is to be communicated. The reply in some instances can simply be a confirmation of the communication. In other instances, the reply can provide results, statistics, conditions, settings, identifying parameters, usage information, a reason why a request could not be implemented or not immediately implemented, an estimated time when a request can be implemented and/or other information. In step 752 the reply is forwarded to the network service 134 where the communication is formatted accordingly, for example, incorporating the reply into a web page, and communicated over the network 132.

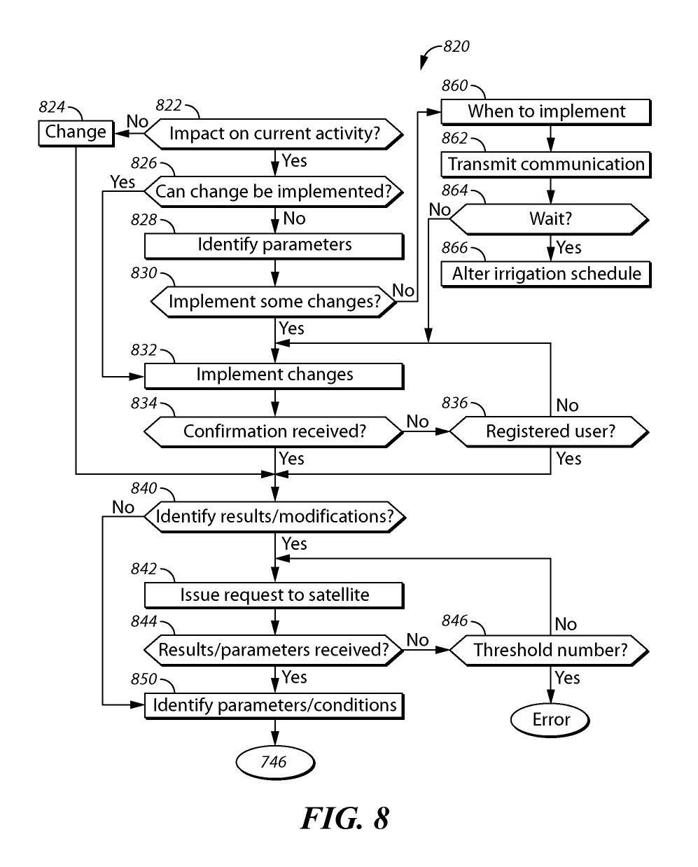

FIG. 8 depicts a simplified flow diagram of an example of a process 820 according to some embodiments to execute step 740 of FIG. 7 that provides for the implementation of the requested change received from the remote user device 152. As described above the implementation can be local at the central control unit 122 and/or can be forwarded out to one or more satellite control units 124 or other devices of the irrigation system 120. In step 822, it is determined whether changes are going to have an impact on and/or effect currently active water delivery and/or irrigation, or whether changes will cause delayed results. Some examples of changes that have an immediate effect on currently active water delivery can include, but are not limited to, when the change includes halting irrigation that is currently and actively being applied when the communication is received (this could include active irrigation in following an irrigation schedule, irrigation previously activated by the user through the remote user device 152 that is now to be halted, or other similar situations), activation of one or more water delivery devices upon receipt of the request, a change to reduce a water flow to a set of water delivery devices while the water delivery devices are actively delivery water when the request is received, and/or other such relevant changes. Similarly, delayed changed can include, but are not limited to, changes to an irrigation schedule that is not scheduled to be activated for a period of time, changes to one or more parameters that may affect water flow and/or irrigation time when irrigation is activated, changes to weather data, and/or other such changes that do not have affects on currently active irrigation and/or are not to have immediate effects.

In those instances where the requested change does not have an immediate impact, for example on irrigation, the process continues to step 824 where the change is recorded for implementation when appropriate (or the process returns to step 742). For example, when the requested change is a change to an irrigation schedule to be later implemented (e.g., implemented later that night) the change to the schedule is recorded such that when the irrigation schedule is activated the change is applied. The process 820 then continues to step 840 to identify results of recorded changes.

Alternatively, when a change will have an impact on current conditions step 826 is entered where it is determined whether the potential change or changes can be implemented to effect current water delivery. Situations may arise that prevent or temporarily prevent the implementation of a requested change. For example, a request may include a request to activate one or more specific water delivery devices. These specific devices, however, may be supplied water from a water pump station that is currently at full capacity delivering water to other water deliver devices and as a result cannot additionally supply water at the requested time to the specific water delivery devices. In some embodiments, when the requested change cannot be implemented at the time requested, step 828 is entered and conditions and/or parameters defining why the request cannot be implemented are identified, such as the flow capacity limits, other overriding conditions and the like. In step 830, the process 820 further determines whether some changes can be implemented. For example, when the user requests that water delivery devices of a defined area be activated, the central control unit 122 may determine that a percentage of the water delivery devices of the defined area can be activated.

Some embodiments include optional step 860 where it is determined when the request could be implemented and/or when the remainder of the request could be implemented. In the example above where the pump is already supplying water at full capacity, the central control unit can identify when the capacity can be made available, for example, based on the irrigation schedule (e.g., when capacity for that pump will be available). In step 862, a communication is forwarded to the remote user device notifying the user of the one or more reasons why the request cannot be implemented. In some implementations, the communication optionally further notifies the user when the request might be activated, of the potential to partially implement the request and/or provides a user with the ability to override current conditions (e.g., halt delivery of water from the pump to the other water deliver devices and direct water to the requested water delivery devices). In step 864 it is determined whether a reply from the remote user device designates to wait until the specific time when the change can be implemented, or whether to implement the identified portion or override and implement the requested change. Step 866 is entered when the central control unit is to wait until the designated time and the irrigation schedule is altered to implement the requested change when appropriate.

Alternatively, the process skips to step 832 to implement the designated change, partial change or implement the override, including communicating the determined changes to the one or more satellite controllers and/or other devices of the irrigation system 120 to implement the changes. These changes may include collateral changes that were not specifically requested but are identified in order to implement the requested change (e.g., halting current irrigation to reduce water flow through a pump so the freed capacity can be used for other water delivery devices). In step 834 it is determined whether a confirmation is received from the one or more satellite controllers and/or devices. In those instances where one or more confirmations are not received, the process shifts to step 836 to determine whether communications have been issued a threshold number of times. When the communication has been issued the predefined number of times an error is generated and the process skips to steps 746 and 750 of the process 720 of FIG. 7 where the error is logged and the user is notified at the remote user device 152. Alternatively, the process 820 returns to step 832 to re-communicate and/or wait for confirmation.

Following step 824 and in those instances where confirmations are received in step 834, step 840 is entered where the process 820 determines whether results of modifications and/or the modifications to parameters, conditions and/or settings at one or more satellite controllers and/or other devices of the irrigation system resulting from the recorded change and/or implementation of the user's requested change are to be identified. In those instances where results and/or the modifications are not to be determined, the process skips to step 850 described below. Alternatively, when modifications are to be determined the central control unit 122 issues requests in step 842 to the appropriate satellite controllers and/or other devices and/or detects communications from the satellite controllers and/or other devices identifying results and/or modifications to parameters, conditions, settings and the like. In step 844 it is determined whether the results, parameters, conditions and/or settings are received. In those instances where they are not received, step 846 is entered to determine whether the request for parameters has been issued a predefined or threshold number of times. An error is generated when the request has been issued the threshold number of times. Alternatively, the process returns to step 842. In step 850, modifications to parameters, conditions, settings and the like that can be determined at the central control unit are determined and/or identified. The process 820 then returns to step 746 to record and/or log events, changes and/or modifications, and then continues to step 750 to generate a reply to the remote user device 152 that can include an acknowledgment of implementation and/or modifications to parameters, settings, conditions and the like.

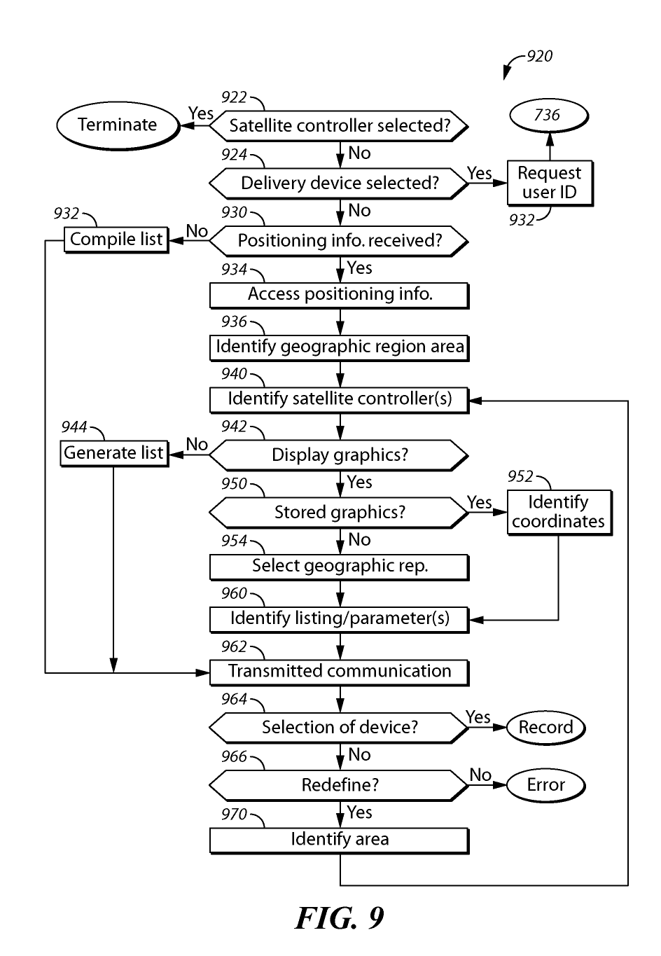

FIG. 9 depicts a simplified flow diagram of an example process 920 according to some embodiments to execute step 734 of FIG. 7 in identifying one or more satellite controllers and/or other devices of the irrigation system 120 that are associated with areas where changes requested by a user are to take effect and/or are to be implemented. In step 922, it is determined whether one or more satellite controllers (or other devices of the irrigation system 120, such as pumps, sensors and/or other devices) have been selected or identified by the user. For example, the request received from the remote user device 152 could include the identification of the one or more satellite controllers. The selection could have been identified through a selection of a list of devices or geographic representations, specifically naming devices, identifying devices through codes (such as command codes as introduced above and fully described below) or other such identifications. When one or more satellite controllers have been identified, the process 920 terminates and returns to step 736 to determine appropriate adjustments for the identified satellite controllers. Alternatively, step 924 is entered when the satellite controllers are not identified to determine whether one or more water delivery devices 130 are identified or have been selected.

One or more water delivery devices 130 can be identified through a specific selection from a listing or a geographic representation, identified by name or numerical representation, identified based on a code (such as command codes as introduced above and fully described below), based on the instruction and/or type of instruction or other such identifications. When a one or more water delivery devices 130 have been identified the process shifts to step 926 where one or more satellite controllers associated with the one or more identified water delivery devices are identified. The process 920 then returns to step 736 to determine appropriate adjustments. Alternatively, the process continues to step 930 to determine whether positioning information, such as a global position, was received and/or can be obtained. The positioning information can correspond with a selected location from a geographic representation, be based on a current location of the remote user device (e.g., specified through GPS), be defined by a user, or the like.

In those instances where positioning information is not received step 932 is entered where a listing of some or all of the satellite controllers and/or other devices of the irrigation system is compiled. In some embodiments, a listing of regions is generated instead of and/or in addition to the listing of the satellite controllers. The regions can define, for example when the area being irrigated by the irrigation system is a golf course, individual holes of the course or groupings of holes (e.g., holes 1-3, 4-6, 5-8, 9, 10-15, 16-18), compass designations (north, south, east, west), a grid, and/or other such regions. The process 920 then skips to step 962 where the listing(s) is (are) communicated to the user, for example, at a remote user device 152.

When positioning information is known the process 920 continues to step 934 where positioning information of the area irrigated by the irrigation system 120 is accessed and compared with the user supplied positioning information. In step 936, a geographic region area proximate to the user supplied positioning information is identified. The size and/or region selected that is proximate to and/or surrounding the identified positioning information can depend on many factors, such as a default region (e.g., defined by a radius around the identified positioning information; based on a type of remote user device (e.g., based on parameters and/or dimensions of a display); predefined areas such as a predefined grid or in the golf course example one or more holes associated with and/or neighboring the defined positioning information), set by a user, based on previous commands, based on previous region sizes, and/or other such areas).

In step 940, one or more satellite controllers 124 and/or water delivery devices 130 that implement irrigation in the identified area proximate to the user-supplied positioning information and/or other devices of the irrigation system (e.g., sensors 142, valves 126, pump stations 128, and the like) that are associated with the identified region are determined. The process then continues to step 942, where it is determined whether a pictorial geographic representation of some portion or the entire identified region can be displayed at the remote user device 152 (e.g., a mapping of an area proximate the region or area. This determination can be based, for example, on information supplied by the remote user device 152 and/or the user, such as a remote device identification, a display type, display parameters, display size, memory capabilities and/or size, and other such factors.

In those instances where the remote user device is incapable of displaying the pictorial geographic representation of the identified area, the process shifts to step 944 where a relevant listing is generated of the one or more identified satellite controllers 124, water delivery devices 130 and/or other relevant devices of the irrigation system 120. In some embodiments, the listing may additionally include parameters associated with the one or more satellite controllers, watering devices and/or other devices, which could depend, for example, on capabilities of the remote device (including screen size, memory capabilities and other such factors). Additionally in some implementations groupings and/or categories can be defined (e.g., a smaller list can be generated by grouping watering devices, or other such groupings or categorizing). Following the generation of the listing in step 944 the process continues to step 962 where the listing is communicated to the remote user device 152.

Step 950 is entered when the remote user device 152 can display the pictorial geographic representation of some or all of the identifying region associated with the selected and/or identified satellite controllers and/or watering devices where it is determined whether the remote user device 152 locally stores a graphical and/or pictorial representation of the area irrigated by the irrigation system. When the remote user device 152 does store locally on the device a pictorial representation of the area irrigated by the irrigation system, step 952 is entered where coordinates associated with the identified area are identified. The coordinates can be longitude and latitude coordinates, based on geographic mapping, a known and/or predefined grid, and/or other such coordinates.

Alternatively, when the remote user device 152 does not store a pictorial representation the process continues to step 954 to select one or more or a portion of a pictorial geographical representation of the identified area, or to generate a pictorial geographical representation of the identified area. Following steps 952 and 954, the process 920 continues to step 960 to identify listings and/or parameters associated with one or more satellite controllers, watering devices and/or other devices associated with the identified area when the listings and/or parameters are to also be displayed with the geographic representation.

In step 962, a communication is transmitted to the remote user device 152 that includes one or more of: the listing of identified satellite controllers and/or watering devices identified in step 932; the coordinates from 952; and/or the pictorial geographic representation of step 954. The communication further requests that the user or remote user device select one or more of the identified satellite controllers 124, water delivery devices 130 and/or other devices. In many instances where a geographical representation is provided the selection can be accomplished via the user actually selecting a representation of the satellite controller, water delivery device or the like (e.g., using a stylus or the like). Some embodiments optionally further include a “redefine” option that allows a user to request that the identified region and/or listing of devices be redefined (for example, redefined to select a larger region, a neighboring region, or other such redefined region) to allow the user to identify other devices not identified.

In step 964, it is determined whether a selection of devices is received from the remote user device 152. When a selection has been received the process records the selected devices and returns to the process 720 of FIG. 7, for example at step 736 to further determine appropriate adjustments for the identified devices. Optionally, when a selection of devices is not received, the process continues to step 966 to determine whether a redefine option selection is received. When a redefine option is selected in step 966, the process continues to step 970 to identify, for example, an area greater than the earlier identified region, and/or to identify one or more satellite controllers, water delivery devices or other devices over a wider region. Typically, this results in a return to step 940 to identify the devices of the irrigation system 120 within the identified larger region. In some embodiments, an error is generated when a time period expires and a selection of devices or a selection of the redefine option is not received in step 966 or 970.

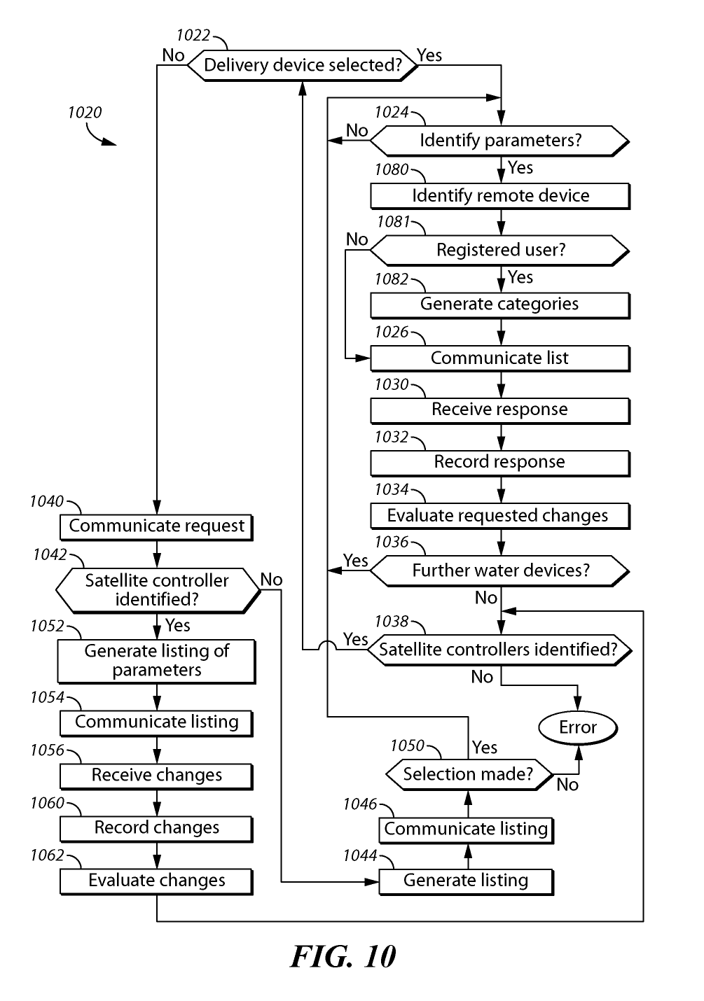

FIG. 10 depicts a simplified flow diagram of an example process 1020 according to some embodiments that execute step 736 of FIG. 7 to identify appropriate changes for the identified one or more satellite controllers, water delivery devices and/or other devices of the irrigation system 120. In step 1022, it is determined whether one or more water delivery devices 130 controlled by the satellite controller identified in step 734 are selected or identified. When a water delivery device is not identified the process skips to step 1040 as described fully below to determine whether a satellite controller or other device of the irrigation system 120 is identified or selected. Alternatively, step 1024 is entered where one or more parameters, conditions, settings and the like are identified for a water delivery device 130. In some embodiments, multiple listings can be generated. For example, a listing can be generated identifying categories of parameters, settings, conditions and the like. Once one or more categories are selected, a listing of sub-categories and/or the parameters, settings, conditions and the like can be generated. The categorizing can be advantageous in navigating through listings, selections and/or options, and when a remote user device 152 has a limited display and/or limited user interface capabilities. By defining categories, navigation through the listings can be simplified in some implementations to allow the user to more easily identify the one or more devices and/or water delivery devices of interest.

For example, following step 1024, optional step 1080 can be included where a device type, display parameters and/or other factors are identified for the device displaying the listing. In step 1081, it is determined whether the receiving device has a limited display relative to the listing and/or whether the listing should be limited and/or categorized. The factors in determining whether to limit or categorize the list can include the total number of items of the listing, the number of entries in a listing that can be displayed at one time on the display, memory capacity of the device displaying the listing and other such relevant factors. In those instances where the device can display the listing while still allowing a user to relatively easily navigate through the listing the process can continue to step 1026. Alternatively, step 1082 is entered where categories and/or sub-categories are utilized (which can be predefined and/or generated based on the characteristics of the device receiving the listing.

In step 1026, the one or more listings of parameters, conditions, settings and the like (or categories and/or sub-categorize) are communicated to the user, for example communicated over the distributed network 132 to the remote user device 152. In step 1030, a response is received. The response can include changes to the settings, conditions, parameters, or can indicate no changes. Similarly, in step 1030 a selection of a category or grouping can be detected and the process 1020 returns to step 1024 to identify the appropriate parameters and/or further sub-categories or groupings associated with the selected category or grouping.

In step 1032, the response is recorded. The recording, in some implementations is a temporary recording. In step 1034, the requested changes are evaluated relative to the implementation of the irrigation system, irrigation schedule, flow control and/or other factors of implementing irrigation, and the central control unit 122 determines how to implement the changes. For example, the central control unit can make adjustments to the irrigation schedule, make adjustments to flow rates, determine instructions to issue to halt irrigation, determine instructions to issue to activate irrigation and/or other such determinations.

The process 1020 then continues to step 1036 where it is determined whether further water delivery devices 130 are identified. When one or more additional water delivery devices are identified, the process returns to step 1024 to further identify parameters, settings and the like for a subsequent water delivery device. Alternatively, when there are no further water delivery devices identified, step 1038 is entered where it is determined whether one or more satellite controllers 124 are identified. When a further satellite controller is identified the process identifies the water delivery devices associated with that satellite controller and returns to step 1022. In those instances where further satellite controllers 124 are not identified, the process 1020 returns to the process 720 of FIG. 7, for example, at step 740 to determine whether changes are to be recorded.

As introduced above, when a water delivery device is not identified in step 1022, the process 1020 skips to step 1040 where a request is communicated to the user, for example, at a remote user device 152 through the distributed network 132. The communication requests that the user identify one or more devices on the system 120 about which the user would like to receive information and/or to which a user would like to adjust parameters and the like. As such, in some embodiments, the request asks the user to select one or more of the satellite controllers, water delivery devices and/or other devices associated with identified area and/or satellite controllers identified in step 734 that are associated with the region where the changes are to take affect. In some implementations, step 1040 can include the optional steps similar to steps 1080-1082 and return to step 1042.

In step 1042, it is determined whether a reply identifies a satellite controller. When the reply does not identify a satellite controller (e.g., the reply requests a listing of water delivery devices), the process 1020 shifts to step 1044 where a listing of water delivery devices 130 associated with the region where the changes are to take affect and/or are to be implemented is generated. In some embodiments, the water delivery devices are grouped and a listing of groupings is forwarded. This listing can be generated similar to the steps of 1080-1082. For example, when the central control unit 122 knows the remote user device has a limited display and/or limited user interface capabilities, groupings can easy navigation through the listings to allow the user to more easily identify the one or more water delivery devices. In step 1046, the listing is communicated to the remote user device 152. As with step 1040, step 1046 in some embodiments, can include optional steps similar to the steps 1080-1082, and return to step 1050. In step 1050, it is determined whether a selection is made. If a selection is made identifying one or more water delivery devices the process returns to step 1024 to identify one or more parameters, conditions, settings and the like of one of the identified water delivery devices. Alternatively, an error can be generated.

When it is determined in step 1042 that the reply to the request sent in step 1040 identifies a satellite controller the process 1020 shifts to step 1052 where a listing of parameters, settings, conditions and the like is generated for the selected satellite controller. As introduced above, in some embodiments, multiple listings can be generated. For example, a listing can be generated identifying categories of parameters, settings, conditions and the like. Once one or more categories are selected, a listing of sub-categories and/or parameters, settings, conditions and the like can be generated. In some implementations, step 1052 implements steps similar to optional steps 1080-1082. In step 1054, the listing of parameters, settings, conditions and the like, and/or categories is communicated to the remote user device. Changes to the parameters, settings, conditions and the like are received in step 1056. In step 1060, the changes are recorded, at least temporarily. The process 1020 then continues to step 1062 where changes are evaluated relative to the implementation of the irrigation system 120, irrigation schedule, flow control and/or other factors of implementing irrigation, and the central control unit 122 determines how to implement the changes, similar to the evaluation of step 1034. The process then returns to step 1038 to determine whether one or more further satellite controllers were identified and changes associated with the one or more satellite controllers to be identified.

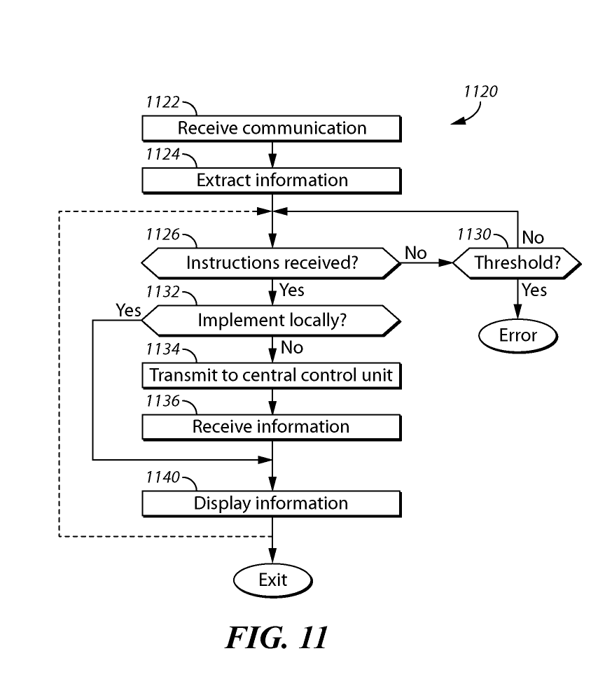

FIG. 11 depicts a simplified flow diagram of an example process 1120 according to some embodiments of a user accessing an irrigation system 120 through a remote user device, such as device 152 or 153, and interacting with the central control unit 122 to obtain information about the irrigation system, issue commands and/or change parameters, settings and the like. In step 1122, a communication is received at the remote user device from a central control unit 122 of the irrigation system 120. In step 1124, information is extracted from the communication and some or all of the information is displayed.

In step 1126, it is determined whether one or more instructions are received from the user through, for example, the user interface 426. When no instructions are received, the process 1120 shifts to step 1130 to determine whether a threshold time has been exceed. If the threshold time has not been exceeded the process returns to step 1126. Alternatively, an error is generated and/or the application exits.

When one or more instructions are received, step 1132 is entered to determine whether the instruction can be implement locally and/or whether information to satisfy the instruction is stored locally (for example, determine whether information about watering devices for a selected satellite controller is locally stored, determine whether identification of all satellite controllers 124 are locally stored and/or other such instructions). When the information is locally available the process skips to step 1140 to display some or all of the information. Similarly, when a command, such as an exit command, a “back” command or other command is received that can be implemented, the process implements the appropriate instructions.

When the information is not locally available, the process continues to step 1134 to generate and transmit a communication to the central control unit 122 requesting the desired information. In some instances, the request identifies a device type, display parameters, and/or other parameters of the remote user device 152 that may be utilized by the central control unit and/or network service 134 in formatting communications and/or information returned to the remote user device 152. Further in some implementations, the communication can include positioning information, such as global positioning information or a location identified by the user (e.g., selected from a geographic representation of some or all of an area being irrigated, selected from a listing of locations, a selection of a device of the irrigation system, identified through a command code, or other such identification. In step 1136, information is received from the central control unit 122. In step 1140, some or all of the information is displayed. The process can then exit or return to step 1126 to await further instructions and/or commands.

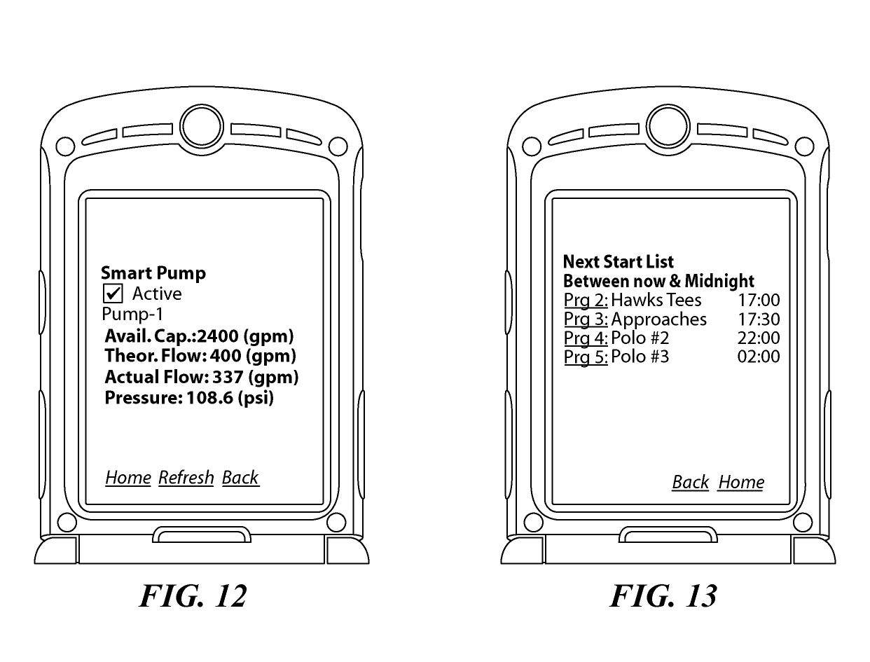

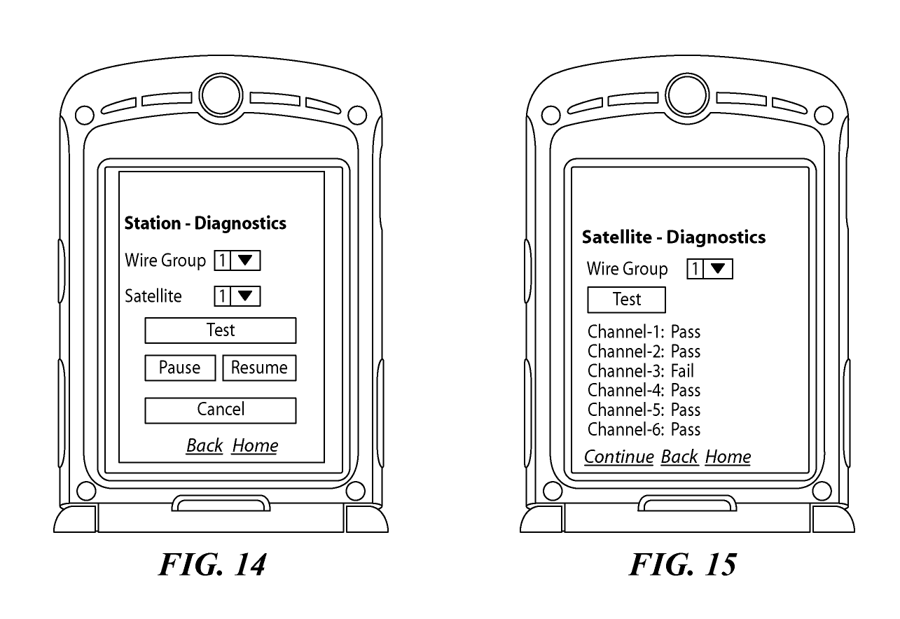

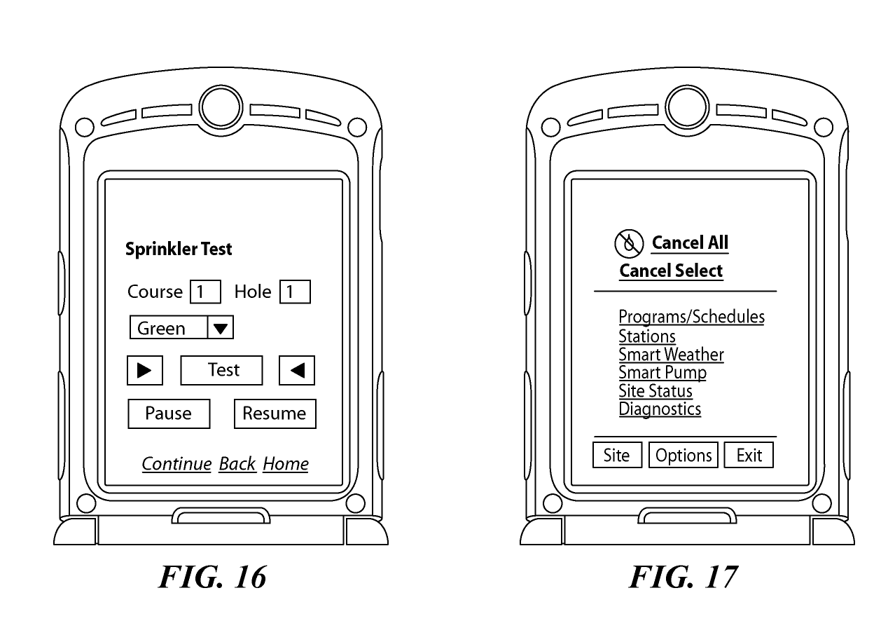

As described above, the present embodiments are capable of providing a remote user with real-time access to an irrigation system to implement control over the system, make changes to the system and/or an irrigation schedule, receive information and other such interaction. FIGS. 12-41 depict simplified examples of mobile devices displaying example information and/or interface displays received from a central control unit 122. The information provides relevant and current information about an irrigation system 120. Some embodiments provide additional navigation options, such as home or main options, back option, refresh option or other such options for navigating through the potential information and/or displays of the irrigation interface provided remotely by and through the central control unit 122. FIG. 12 shows an example of a smart pump display with information about pump operation. FIG. 13 shows an example of a next start link display with a listing of various irrigation programs to be implemented. FIG. 14 shows an example of a station diagnostic or testing display with selectable options or buttons to implement testing, pause, resume and/or cancel. FIG. 15 shows a station diagnostic or testing display with a listing of results. FIG. 16 shows an example sprinkler or other water deliver device testing display with options to select one or more sprinklers, such as identifying a general region of an area being irrigated (e.g., golf course 1) and a more particular area (e.g., hole 1), and sprinklers or an further focused area (e.g., sprinklers of a green), shift to a next define area, activate a test, pause or resume a test. FIG. 17 shows an example of an user interface display (e.g., a main interface) that allows a user to navigate through the irrigation control by, for example, selecting one entry of a listing of options (e.g., selecting programs, stations, smart weather, smart pump, site stacks, diagnostics, a site, options, exit, and/or other such options).

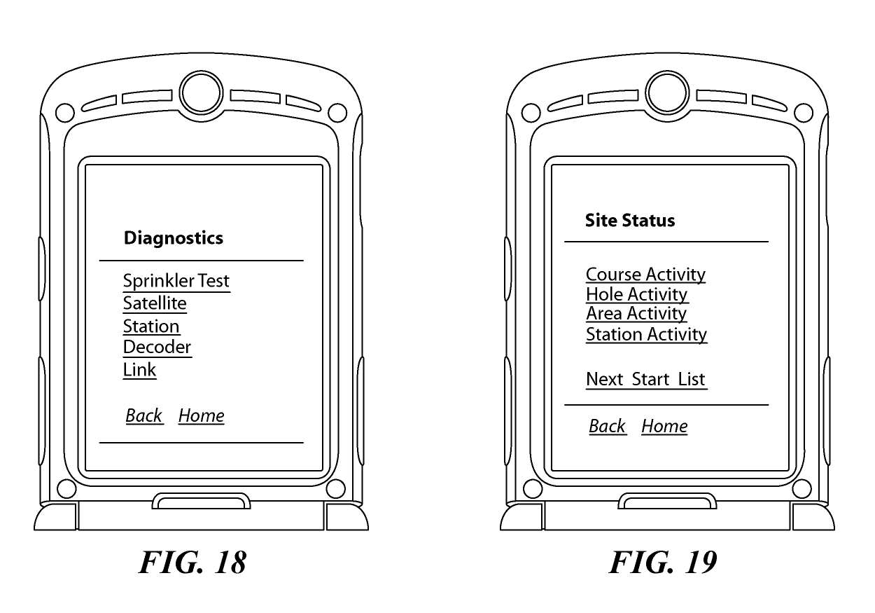

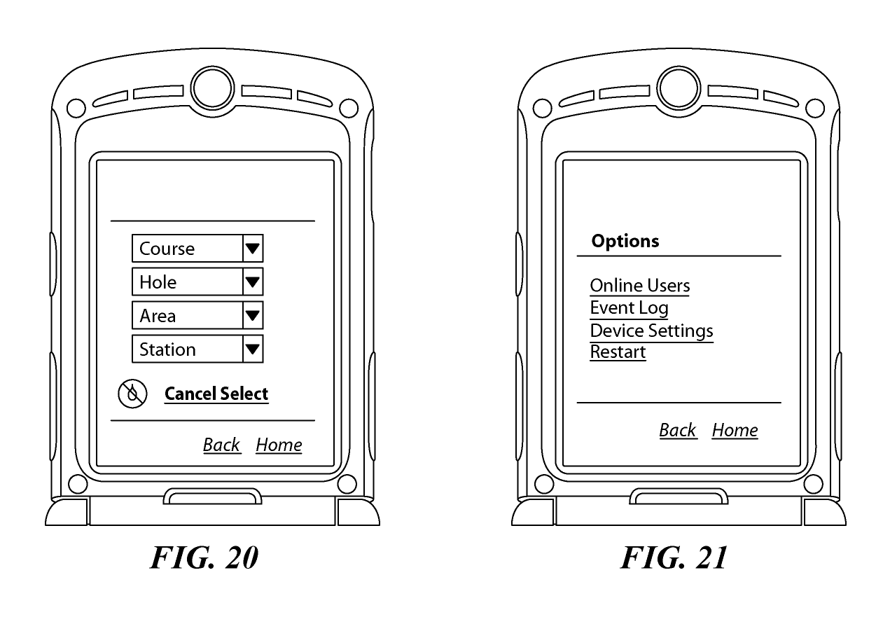

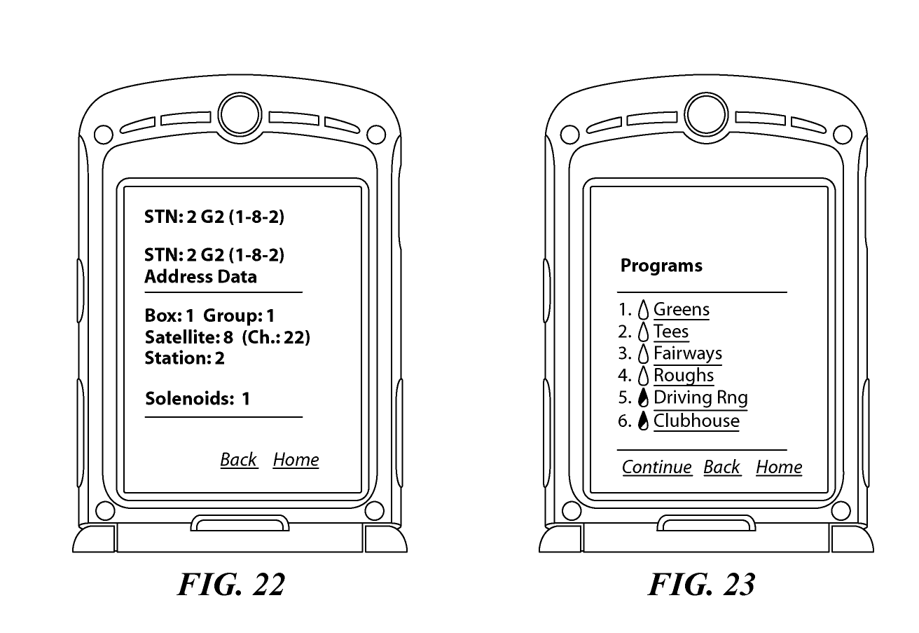

FIG. 18 shows an example of a diagnostic display with a listing of aspects of the irrigation system that can be tested, such as sprinklers, satellite controllers, stations, decoders, links or other such aspects of the irrigation system. FIG. 19 shows an example of a site status display showing a listing of a status information that can be retrieved from the central control unit 122, such as course activity, hole activity, area activity, station activity, next start list or other such options. FIG. 20 shows an example of a navigation display allowing a user to select one of the navigation options, such as selecting a course, hole, area, station or other such selections. FIG. 21 shows an example of an options display providing a user with a listing of options for utilizing the irrigation interface provided by the central control unit, such as on line users, event log, device settings, restart and other such options. FIG. 22 shows a status display that provides a user with information about a device or aspect of the irrigation system, such as station information related to a defined box and group, associated with an identified satellite controller and the station and associates solenoid. FIG. 23 shows an example of an irrigation program selection display that shows a listing of programs that can be accessed, such as greens programs, tee box programs, fairway programs, rough programs, driving range programs, club house programs and/or other such programs. A continue option may be provided in some displays when a listing cannot be fully displayed through a single display.

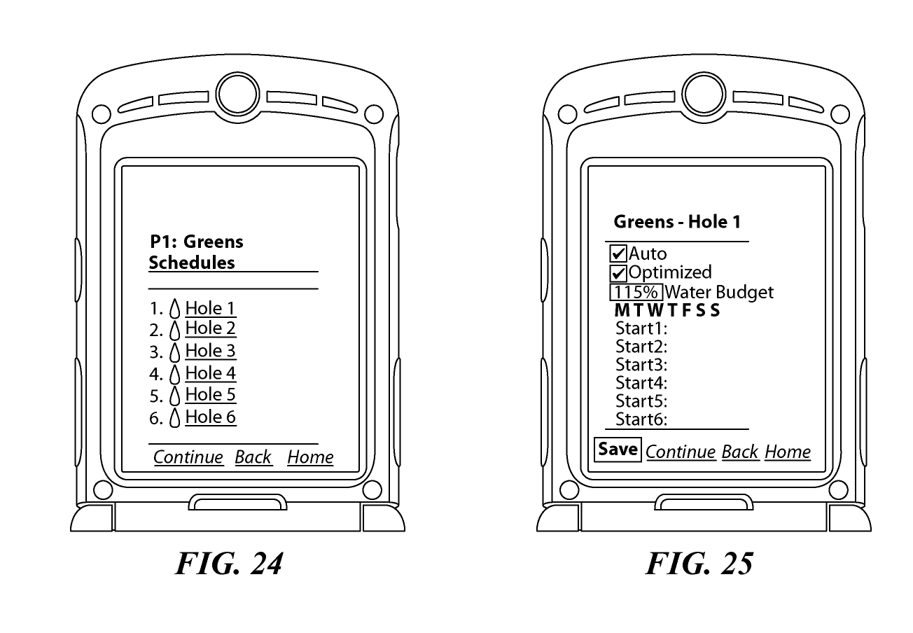

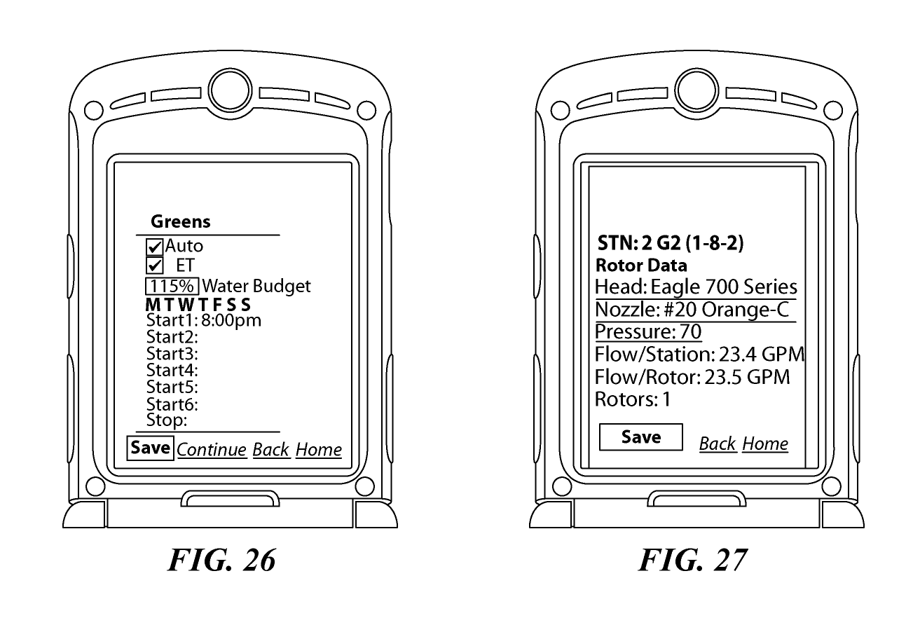

FIG. 24 shows an example of a program schedule display that identifies a listing of an organization of a program, for example a program that was selected through the display of FIG. 23. The program schedule display can list multiple sub-programs or organizations of the program, such as hole 1, hole 2, hole 3, etc. FIG. 25 shows an example of a program definition display that provides a user with options in defining a schedule for a selected program (e.g., program selected through the display of FIG. 24), which may include sever program options, such as defining irrigation is automated, whether ET data and/or water optimization is employed, a water budget level, timing indications (e.g., days, hours, minutes, and/or other such timing) and other such options. A save option may be provided in some displays indicating that the central control unit 122 should record the designations and/or changes. FIG. 26 shows an example of a program definition display that may be applied more generally than the program schedule defined in FIG. 25. For example, the schedule defined in FIG. 25 may be specific for the green of hole 1, while the program schedule defined in FIG. 26 may be a general schedule for greens that are not otherwise defined by a specific schedule.

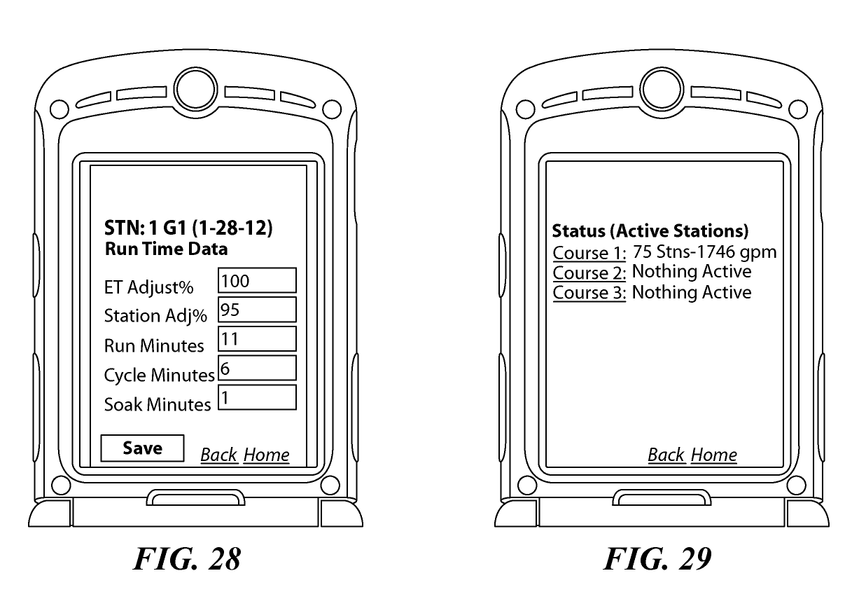

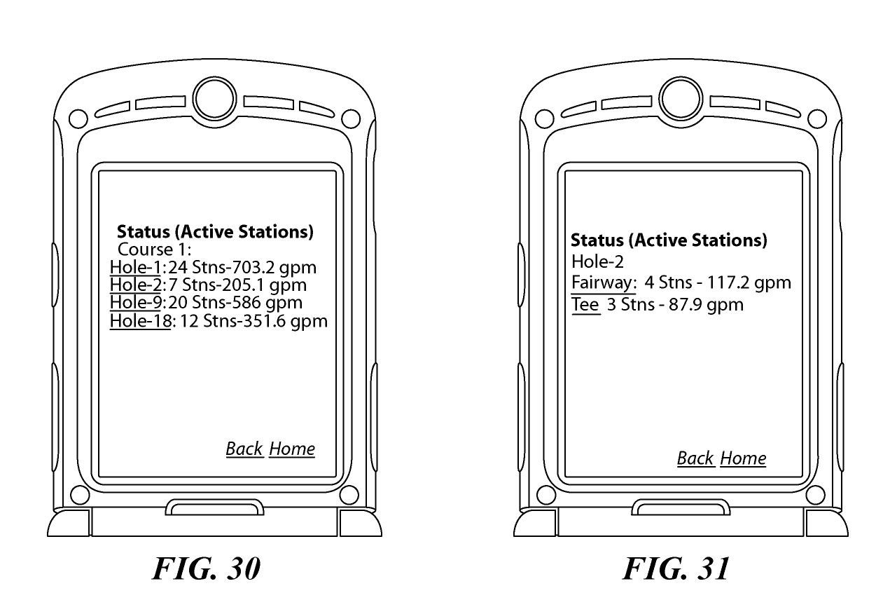

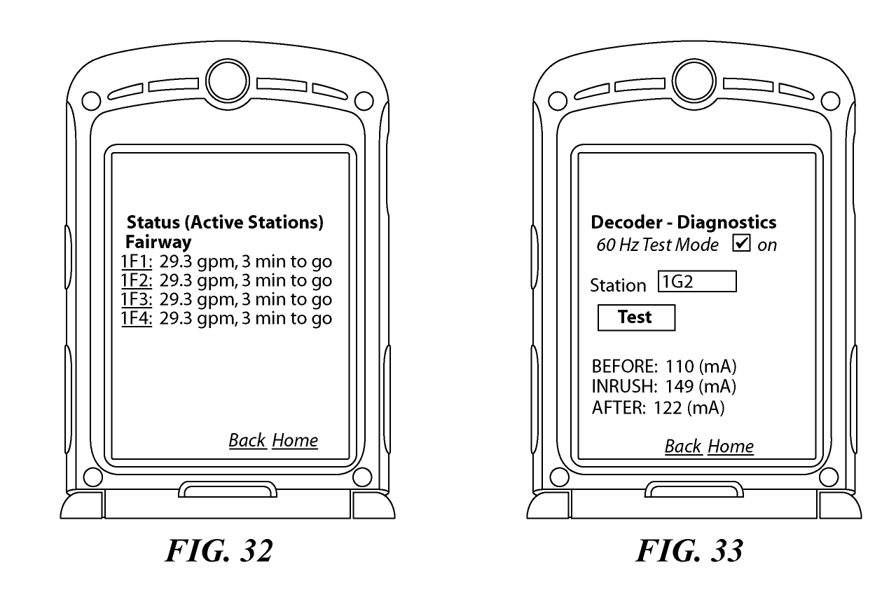

FIG. 27 shows an example of irrigation device status display that shows status information about one or more devices of the irrigation system, such as status information about a rotor, which might include a device identifier, type of device, parameters and settings of the device, and may provide options to alter the information. FIG. 28 shows an example of a runtime display that provides information about runtime, such as ET adjustment percentage, station adjustment percentage, runtime in minutes, cycle minutes, soak minutes and/or other such information. FIG. 29 shows an example of a general status display that displays general status information about the irrigation system such as identifying a listing of portions of the irrigation system and which portions of an irrigation system are active. The general status display may further allow a user to select one of the portions obtain further information. FIG. 30 shows a further example of a status display that shows further details associated with a portion of the irrigation system selected, for example through the general status display of FIG. 29 (e.g., course 1). This display may identify a listing of areas of course 1 that are active, for example, identifying holes, and this listing may also be selectable. FIG. 31 shows a further example of a status display based on a selection, such as a selection through the display of FIG. 30, providing further details about the status, for example of a specific hole (e.g., hole 2). FIG. 32 shows yet another example of a status display that may provide still further detailed status information, such as details about water deliver devices associated with a selection from the display of FIG. 31 (e.g., water delivery devices of the fairway of hole 2).

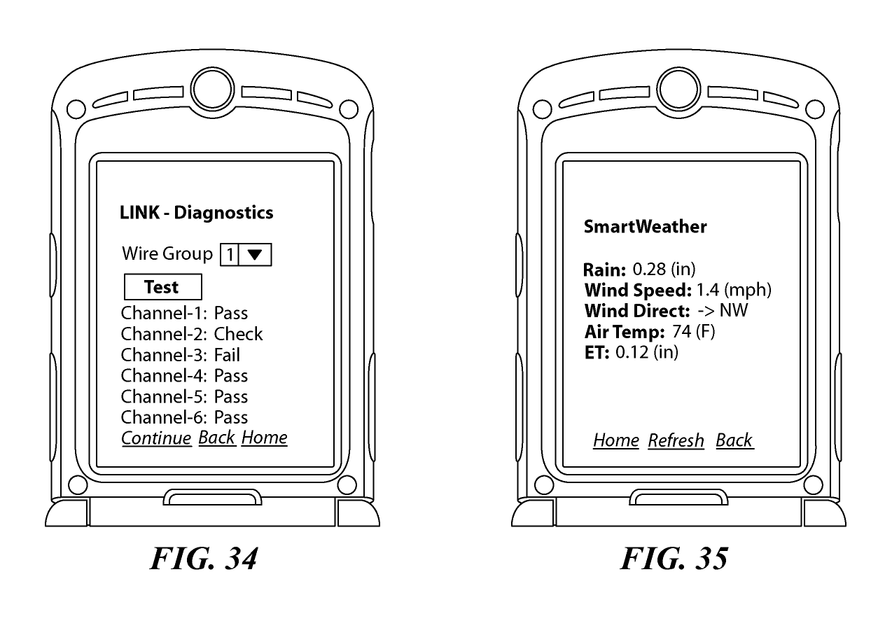

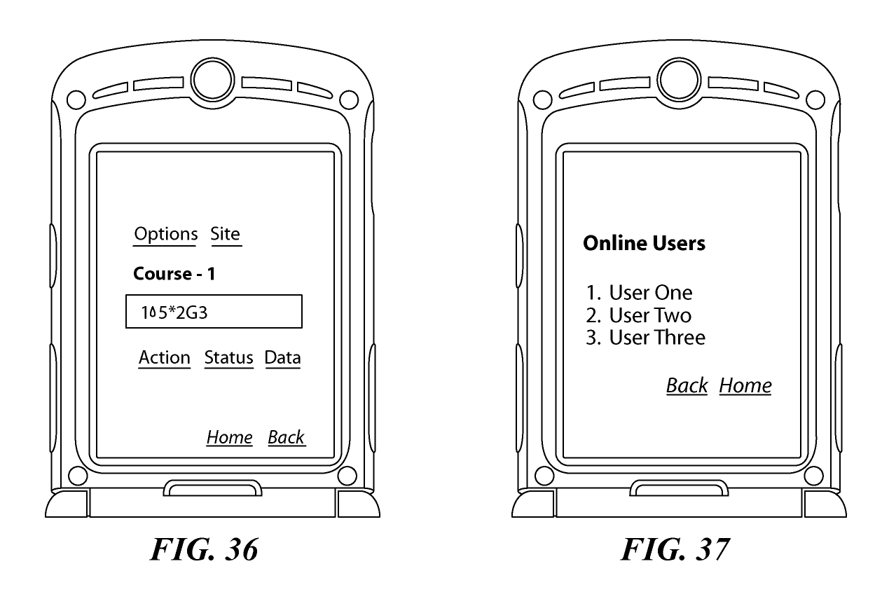

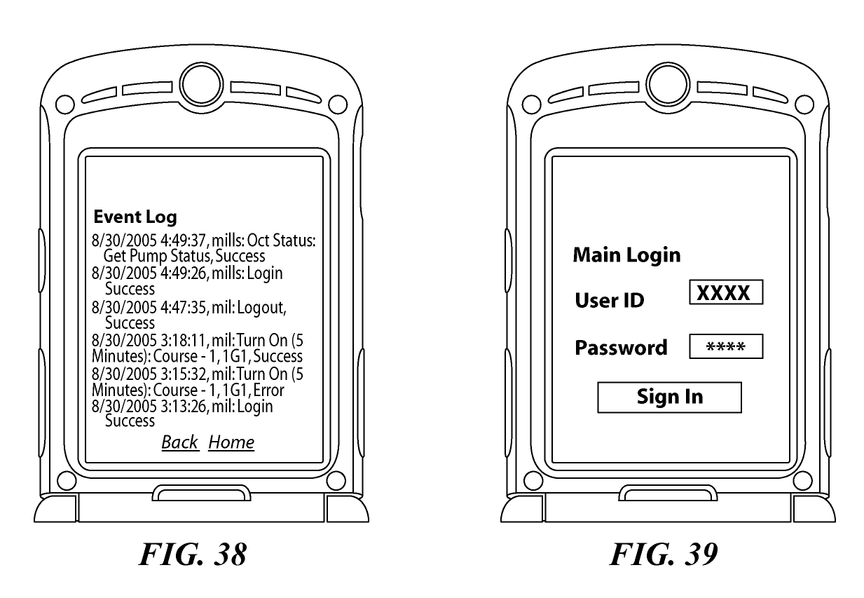

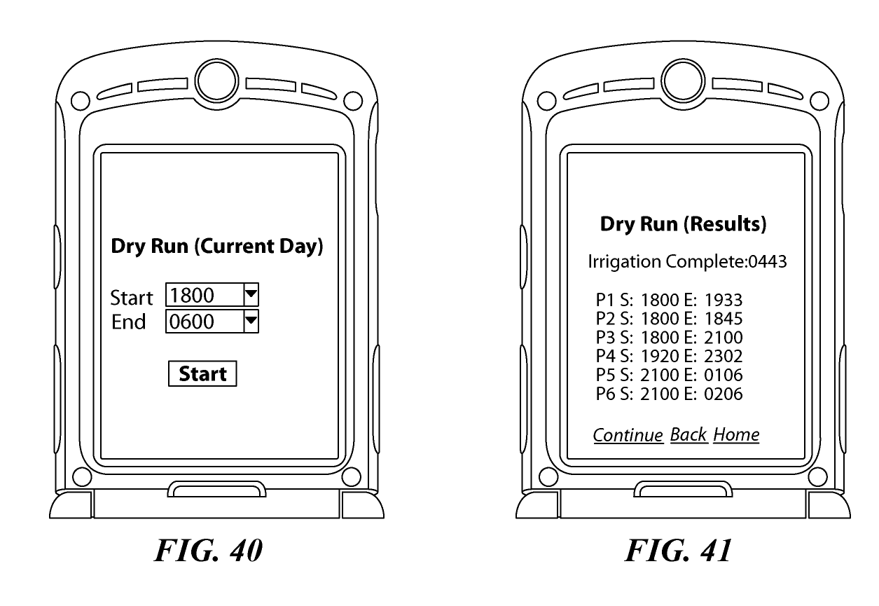

FIG. 33 shows an example of a decoder diagnostic display that allows a user to identify a device, to implement a test and in some instance displays received results of the test. FIG. 34 shows another example of a diagnostic display such as a link diagnostic display allowing a user to diagnose communication links of the irrigation system. FIG. 35 shows an example of a smart weather display that provides current, anticipated and/or historic weather data. FIG. 36 shows an example of a command display that allows a user to enter commands, for example using command codes. FIG. 37 shows an example of an online user's display that lists the users actively logged in to the central control unit and/or can log into the central control unit. FIG. 38 shows an example of a log display that displays a log of events. FIG. 39 shows an example of a main login display that allows a user to log into the central control unit 122 to issue commands and/or receive information. FIG. 40 shows an example of a dry run display that identifies times of implementation. FIG. 41 shows an example of a dry run results display that is provided based on the results over the dry run implemented through the dry run display of FIG. 40. FIGS. 12-41 are simple examples of interface displays that can be communicated to the remote device to provide the user with the ability to interact with the central control unit, is not to be viewed as an exhaustive list and other such displays can be provided.

Further, because the central control unit dynamically provides the interface to the remote device the displays can vary and change. The user interface communicated to the remote device from the central control unit is definable by the central control unit. The user interface at the remote that allows irrigation control is dynamic and changeable, typically is not limited by the functionality of buttons and firmware of the remote device.

Additionally as described above, the irrigation control through the present embodiments allows remote access to the irrigation system and control over the irrigation system. In some instances the remote access and interaction with the irrigation control system provides for remotely accessing a distributed network 132 and accessing the central irrigation control unit 122 of the irrigation system 120 from over the distributed network. A request is communicated to the irrigation control unit to take an action in controlling irrigation and real-time irrigation parameter information is received in response to the request. The received real-time information can include diagnostic information compiled according to current conditions within the irrigation system 120 controlled by the central irrigation control unit 122 and comprises accurate and current information existing at the time the central irrigation control unit 122 processes the request for real-time information, where the real-time information is different than theoretical information based on defined parameters, and generally is determined based on measurements performed in response to the request that the action be taken.

The action be taken by the central irrigation control unit 122 can include one or more actions to control irrigation such that the action is to be taken immediately upon receipt by the central irrigation control unit. Based on the action the real-time information can include one or more changes in one or more irrigation conditions and/or parameters resulting from the action taken. Further, the real-time information can comprise a notification why the action cannot be implemented immediately at the time the request is received. In some instances that notification received as at least part of the received real-time information can include an estimated time when the action is to be implemented, identify that water pump capacities would be exceeded should the action be immediately implemented, and/or other such conditions.

In many instances, the requesting the action be taken further identifies at least one or more water delivery devices 130 in the request. Additionally or alternatively, the requested action can identify one or more satellite irrigation controller 124 controlled through the central irrigation control unit 122. The identification of the water deliver device and/or satellite controller can be made, in some embodiments, by navigating through a tree structure listing, and selecting the desired water delivery device(s) within the tree structure listing such that the request incorporates the identification of the selected water deliver device(s). Alternatively, the identification can be implemented by navigating through a pictorial representation displayed on the remote device 152 of an area irrigated by an irrigation system 120 and depicting a representation of one or ore satellite irrigation controllers 124, valves 126, water delivery devices 130, pumps 128 and/or other such devices of the irrigation system 120, and selecting the desired satellite controller 124, water deliver device 130 or other device represented within the displayed pictorial representation of the area irrigated. The navigation through the pictorial representation can be implemented by buttons 438, a touch screen, use of a stylus, and/or other such interactions with the remote user device 152.

Some embodiments further determine current positioning information where the remote user device is currently located at the time or proximate in time to when the request is made, and displays a portion of a pictorial representation of a region of the area irrigated proximate to the identified positioning information within the area irrigated and corresponding to the positioning information. The pictorial representation may be received that represents at least a region proximate to the positioning information within an area irrigated by the irrigation system controlled by the central irrigation control unit.

As further described above, the system to implement and/or control irrigation allows users to access the irrigation system 120 through remote user devices 152. The user device 152 is communicationally coupled with a distributed network 132, the user device comprises a processor 422, a user interface 426 coupled with the processor, a communication transceiver 432 coupled with the processor, where the communication transceiver receives real-time irrigation information including current and actual information communicated over the distributed network from the irrigation central control unit 122, and one or more memory devices 424 storing a network browser application 446 implemented by the processor that when implemented by the processor utilizes the real-time irrigation information received from over the distributed network 132 to notify a user device 152 of at least some of the real-time irrigation information. Typically, the user device further includes a display 436 coupled with the processor to display the at least some of the real-time irrigation information from the network browser application, and a user input (e.g., buttons 438, stylus or the like) coupled with the processor to receive inputs from a user and forward the inputs to the processor. The network browser application can generate display images including at least some of the real-time irrigation information that are displayed on the display 436. Further, the network browser application receives the user inputs and formats the user inputs (e.g., into a web page) to be transmitted over the distributed network by the communication transceiver.

While the invention herein disclosed has been described by means of specific embodiments and applications thereof, numerous modifications and variations could be made thereto by those skilled in the art without departing from the scope of the invention set forth in the claims.

What is claimed is:

1. An irrigation control system, comprising:
an irrigation system comprising a plurality of satellite irrigation controllers coupled with water delivery devices; and
a computer coupled with a distributed network and the local irrigation system, the computer comprises a processor coupled with memory storing software that is implemented by the processor, where the software comprises:
a central irrigation control that when implemented through the processor communicates with and controls the plurality of satellite irrigation controllers to implement irrigation by activating one or more of the water delivery devices; and
a network service that when implemented by the processor provides a communication interface between the central irrigation control and the distributed network allowing irrigation information to be communicated between the central irrigation control and at least one remote device accessing the distributed network.

2. The irrigation control system of claim 1, wherein the central irrigation control receives an instruction communicated through the network service from over the distributed network during irrigation to alter the irrigation, and communicates with one or more satellite controllers during irrigation to alter the irrigation in response to the received instruction.

3. The irrigation control system of claim 2, wherein the central irrigation control detects changes to irrigation parameters as a result of the changes implemented during irrigation in response to the received instruction and communicates through the network service and over the distributed network to the at least one remote device one or more of the changes to irrigation parameters.

4. The irrigation control system of claim 1, wherein the central irrigation control determines real-time status information including current and actual status information in response to a received request communicated through the network service from over the distributed network, and communicates the real-time status information through the network service and over the distributed network.

5. The irrigation control system of claim 4, wherein the central irrigation control communicates an irrigation control interface over the distributed network that is displayed at the at least one remote device configured to allow a user at the at least one remote device to interact with the central irrigation control.

6. A method of implementing irrigation, the method comprising:
receiving a remote request at an irrigation central control unit from over a distributed network;
determining in response to the remote request real-time information comprising current and actual information existing at the time of identifying the real-time information regarding irrigation implemented through satellite irrigation controllers controlled by the irrigation central control unit; and
communicating over the distributed network the real-time information.

7. The method of claim 6, wherein communicating the real-time information comprises populating a web page at the irrigation central control unit with the real-time information and communicating the web page.

8. The method of claim 7, wherein communicating the real-time information comprises forwarding the real-time information to a network service application, populating the web page with the real-time information at the network service application and communicating the web page over the distributed network from the network service application of the irrigation central control unit.

9. The method of claim 6, wherein the receiving the request comprises receiving an instruction communicated over the distributed network during an implementation of irrigation by the satellite controllers as controlled by the irrigation central control unit;
identifying a change to the irrigation in response to the received instruction; and
communicating from the irrigation central control unit with one or more of the satellite controllers during the implementation of the irrigation to alter the irrigation implemented by the one or more satellite controllers according to the identified change in response to the received instructions.

10. The irrigation control system of claim 9, wherein the determining the real-time information comprises detecting at the irrigation central control unit changes to current irrigation parameters as a result of the altered irrigation implemented during irrigation in response to the received instruction; and
the communicating comprises generating a reply comprising one or more of the changes to irrigation parameters.

11. The method of claim 6, further comprising:
identifying geographic information associated with the remote request, and the communicating the real-time information comprises communicating the geographic information over the distributed network.

12. The method of claim 11, wherein the geographic information comprises a pictorial representation of an area irrigated by one or more water delivery devices controlled by one or more of the satellite irrigation controllers.

13. The method of claim 11, further comprising:
receiving over the distributed network positioning information from a user device;
identifying one or more water delivery devices controlled by one or more of the satellite irrigation controllers proximate the positioning information;
retrieving water delivery device information about the one or more water delivery devices; and
the communicating the real-time information comprises communicating the water delivery device information.

14. The method of 11, further comprising:
receiving over the distributed network positioning information from a user device;
identifying one or more of the satellite irrigation controllers proximate the positioning information; and
the identifying geographic information comprises identifying geographic information of the one or more satellite irrigation controllers.

15. The method of 6, further comprising:
receiving over the distributed network positioning information from a user device;
identifying a first satellite controller of the satellite controllers proximate the positioning information;
retrieving current irrigation conditions from the first satellite controller in response to the remote request; and
the communicating the real-time information comprises communicating the current irrigation conditions of the first satellite controller.

16. The method of claim 6, further comprising:
identifying geographic information associated with the request;
generating a pictorial representation of an area irrigated by one or more water delivery devices controlled by one or more of the satellite irrigation controllers proximate the identified geographic information; and
the communicating the real-time information comprises communicating the pictorial representation over the distributed network.

17. The method of claim 6, further comprising:
determining whether a device transmitting the request is capable of displaying a graphical representation; and
identifying geographic information associated with the request such that the communicating the real-time information comprises communicating the geographic information over the distributed network when it is determined that the device can display the graphical representation.

18. The method of claim 6, wherein the determining the real time information comprises:
immediately issuing in response to the remote request a query to a satellite controller requesting current conditions;
receiving a response from the satellite controller comprising satellite controller conditions; and
incorporating the satellite controller conditions into the real time information.

19. An irrigation control system, comprising:
a central irrigation control system comprising a processor and memory that stores software implemented by the processor such that the processor is adapted to:
communicate with and control a plurality of satellite irrigation controllers to implement irrigation through water delivery devices;
communicate over a distributed network to receive a remote request from over the distributed network from a remote device;
determine in response to the remote request real-time information comprising current and actual information existing at the time of identifying the real-time information regarding irrigation implemented through the plurality of satellite irrigation controllers; and
communicate over the distributed network the real-time information.

20. The irrigation control system of claim 19, wherein the processor is further adapted to:
receive an instruction communicated through the distributed network during irrigation to alter the irrigation, and communicate with one or more satellite controllers during irrigation to alter the irrigation in response to the received instruction.

21. The irrigation control system of claim 20, wherein processor is further adapted to detect changes to irrigation parameters as a result of the changes implemented during irrigation in response to the received instruction and communicate over the distributed network one or more of the changes to irrigation parameters.

22. The irrigation control system of claim 19, wherein the processor is further adapted to identify geographic information associated with the remote request, and communicate the geographic information over the distributed network.

23. The irrigation control system of claim 22, wherein the processor is further adapted to:
receive over the distributed network positioning information from the remote device;
identify one or more water delivery devices controlled by one or more of the plurality of satellite irrigation controllers proximate the positioning information;
retrieve water delivery device information about the one or more water delivery devices; and
communicate the water delivery device information over the distributed network to the remote device.

24. The irrigation control system of claim 19, wherein the processor is further adapted to communicate an irrigation control interface over the distributed network to be displayed at the remote device that is configured to allow a user at the remote device to interact with the central irrigation control system.

25. A method of controlling irrigation, comprising:
remotely accessing a distributed network;
accessing a central irrigation control unit of an irrigation system from over the distributed network;
requesting an action be taken by the central irrigation control unit in controlling irrigation; and
receiving real-time irrigation parameter information in response to the request.
